(19) United States
(12) Patent Application Publication
(10) Pub. No.: US 2025/0341632 A1
(43) Pub. Date: Nov. 6, 2025

(54) SIGNAL PROCESSING DEVICE AND SIGNAL PROCESSING METHOD

(71) Applicant: NEC Corpration, Minato-ku, Tokyo (JP)

(72) Inventors: Yuki YAMAGUCHI, Tokyo (JP); Taichi TANAKA, Tokyo (JP); Masato TODA, Tokyo (JP)

(73) Assignee: NEC Corpration, Minato-ku, Tokyo (JP)

(21) Appl. No.: 18/870,699

(22) PCT Filed: Jun. 3, 2022
(86) PCT No.: PCT/JP2022/022634

§ 371 Date: Dec. 2, 2024

(51) Int. Cl. G01S 13/90; G06V 10/74

(52) U.S. Cl. CPC G01S 13/9021; G06V 10/761

(57) ABSTRACT

The signal processing device 10 includes a three-dimensional information with reliability reconstruction unit 11 which generates three-dimensional information with reliability including three-dimensional information constructed with estimated values of intensity and a phase at a three-dimensional position in a steady state reconstructed using an observed SAR image, and information indicating reliability of the three-dimensional information, and a simulated SAR image generation unit 12 which generates a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.

### TECHNICAL FIELD

This invention relates to a signal processing device and a signal processing method using a SAR image.

### BACKGROUND ART

Patent literatures 1-4 describe a change detection technology using a SAR (Synthetic Aperture Radar) image.

### CITATION LIST

### Patent Literature

Patent Literature 1: European Patent Application Publication No. 3540462
Patent Literature 2: GB Patent Application Publication No. 2553284
Patent Literature 3: U.S. Pat. No. 10,571,560
Patent Literature 4: International Publication 2008/016153

### SUMMARY OF INVENTION

### Technical Problem

However, Patent literatures 1-4 do not describe a technique for detecting change from the steady state in the SAR image to be analyzed using a complex correlation coefficient. The steady state is represented, for example, by a given complex image. The imaging condition of the complex image representing the steady state is consistent with the imaging condition of the SAR image to be analyzed. For example, the disaster countermeasure support method described in patent literature 4 uses only intensity of reflected waves. Accordingly, each of the techniques described in patent literatures 1-4 cannot correctly detect change from the steady state.

In this specification, “steady state” refers to a state in which there is no change in the object of observation, or even if there is change in the object of observation, the degree of the change is negligible.

One purpose of this invention is to provide a signal processing device and a signal processing method that can correctly detect a change of an object.

### Solution to Problem

A signal processing device according to the present invention includes three-dimensional information with reliability reconstruction means for generating three-dimensional information with reliability including three-dimensional information constructed with estimated values of intensity and a phase at a three-dimensional position in a steady state reconstructed using an observed SAR image, and information indicating reliability of the three-dimensional information, and simulated SAR image generation means for generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.

A signal processing method, implemented by a processor, includes generating three-dimensional information with reliability including three-dimensional information constructed with estimated values of intensity and a phase at a three-dimensional position in a steady state reconstructed using an observed SAR image, and information indicating reliability of the three-dimensional information, and generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image

A signal processing program according to the present invention causes a computer to execute generating three-dimensional information with reliability including three-dimensional information constructed with estimated values of intensity and a phase at a three-dimensional position in a steady state reconstructed using an observed SAR image, and information indicating reliability of the three-dimensional information, and generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.

### Advantageous Effects of Invention

According to the present invention, it is possible to correctly detect a change in an object

### BRIEF DESCRIPTION OF DRAWINGS

FIG. 1 It depicts an explanatory diagram showing a relationship between the coherence value, and intensity correlation and phase correlation between SAR images.

FIG. 2 It depicts an explanatory diagram showing an example of a SAR satellite imaging a structure.

FIG. 3 It depicts an explanatory diagram showing an example of layover phenomenon that occurs in a SAR image.

FIG. 4 It depicts a block diagram showing a configuration example of the signal processing device in a reference example.

FIG. 5 It depicts an explanatory diagram showing an example of a method estimating a complex reflectivity distribution at a pixel corresponding to the azimuth-range position by SAR tomography.

FIG. 6 It depicts a flowchart showing signal processing performed by a signal processing device in a reference example.

FIG. 7 It depicts a flowchart showing a three-dimensional information reconstruction process in a reference example.

FIG. 8 It depicts a flowchart showing a simulated SAR image generation process in a reference example.

FIG. 9 It depicts an explanatory diagram for explaining a change detection process when a SAR image showing a steady state includes information other than the steady state.

FIG. 10 It depicts a block diagram showing a configuration example of the signal processing device of the first example embodiment.

FIG. 11 It depicts an explanatory diagram for explaining an improved change detection process when an observed SAR image showing a steady state includes information other than the steady state.

FIG. 12 It depicts a block diagram showing other configuration example of the signal processing device of the first example embodiment.

FIG. 13 It depicts an explanatory diagram for explaining other improved change detection process when an observed SAR image showing a steady state includes information other than the steady state.

FIG. 14 It depicts a flowchart showing signal processing performed by the signal processing device of the first example embodiment.

FIG. 15 It depicts a flowchart showing a three-dimensional information reconstruction process in the first example embodiment.

FIG. 16 It depicts a flowchart showing a simulated SAR image generation process in the first example embodiment.

FIG. 17 It depicts a flowchart showing signal processing performed by the signal processing device of another aspect of the first example embodiment.

FIG. 18 It depicts a flowchart showing a three-dimensional information reconstruction process in another aspect in the first example embodiment.

FIG. 19 It depicts a flowchart showing a simulated SAR image generation process in another aspect in the first example embodiment.

FIG. 20 It depicts a block diagram showing a configuration example of the signal processing device of the second example embodiment.

FIG. 21 It depicts an explanatory diagram showing a specific example of a first change detection process performed by the first change detection unit.

FIG. 22 It depicts a flowchart showing signal processing performed by the signal processing device of the second example embodiment.

FIG. 23 It depicts a flowchart showing the first change detection process performed by the first change detection unit.

FIG. 24 It depicts a block diagram showing a configuration example of the signal processing device of the third example embodiment.

FIG. 25 It depicts a flowchart showing signal processing performed by the signal processing device of the third example embodiment.

FIG. 26 It depicts a flowchart showing the second change detection process performed by the second change detection unit.

FIG. 27 It depicts a block diagram showing one example of a computer with a CPU.

FIG. 28 It depicts a block diagram showing the main part of the signal processing device.

### DESCRIPTION OF EMBODIMENTS

In image analysis, background subtraction detection and anomaly detection techniques

are known. They are used, for example, to detect objects other than permanently existing objects such as structures. They are also used to detect a condition on the ground such as new construction or collapse of structures. Objects other than permanently existing objects include a vehicle and an aircraft, for example. However, a vehicle and an aircraft can also be considered permanently existing objects if they are present over the monitoring period.

The above technique detects changes in the image to be analyzed relative to image data representing a steady state. Image data representing a steady state is selected from image data acquired and stored in the past. The image data representing a steady state may be generated from stored image data.

A SAR image is a complex image that has information on the intensity of the irradiated microwaves and phase information for each pixel. One of change detection techniques for a complex image is the coherent change detection technique.

The coherent change detection technique detects minute change from a steady state based on the value of the complex correlation coefficient (coherence) which indicates the degree of similarity between images. The coherence which is the complex correlation coefficient between SAR images is one indicator of intensity correlation and phase correlation in the local area between SAR images. Since the change detection technique using coherence uses phase information in addition to intensity, it can increase the sensitivity of change detection.

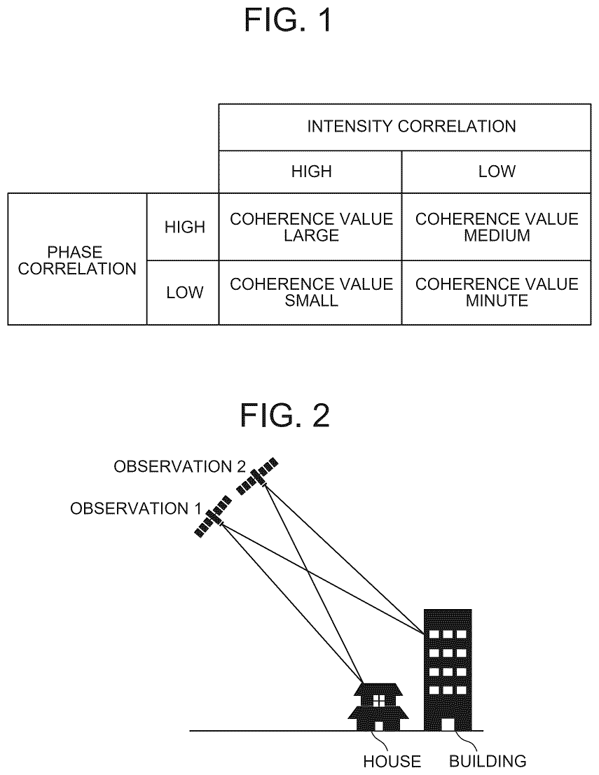

FIG. 1 is an explanatory diagram showing a relationship between the coherence value, and intensity correlation and phase correlation between SAR images. As shown in FIG. 1, the larger the coherence value, the greater the similarity in intensity between SAR images and the greater the similarity in phase between SAR images. In other words, the larger the coherence value, the less change there is between SAR images.

As shown in FIG. 1, the smaller the coherence value, the lower at least one of intensity similarity between SAR images and similarity in phase between SAR images. In other words, the smaller the coherence value, the more change there is between SAR images.

In addition, the coherence value is an indicator that is more sensitive to phase change than to change in intensity of the reflected wave. As shown in FIG. 1, the coherence value is lower when the phase similarity is lower than the intensity similarity. The coherent change detection technique can also capture the switching of reflectors.

One problem is to generate a complex image representing a steady state suitable for SAR image analysis.

SAR images observed by a SAR satellite orbiting the earth have different imaging conditions for each observation. The imaging conditions include the position of the SAR satellite at the time of observation, the coordinates of an area to be analyzed (analyzed area), the resolution, etc. Therefore, even when an area under the steady state is observed, differences occur between SAR images acquired for each observation. In particular, when an area with structures of different heights, such as an urban area, is observed, the phase information changes significantly from observation to observation. In such a situation, if a complex image with consistent imaging condition (a complex image representing a steady state) cannot be generated, change in the image due to a difference in an imaging condition is taken as change that occurred in the area to be analyzed. Namely, change in the image due to a difference in an imaging condition is a factor in false detection. It should be noted that a SAR satellite is a satellite on which a SAR is mounted.

There is a height of a structure as one reason why different imaging conditions result in different observed SAR images, even when the target of observation is observed under the steady state. FIG. 2 is an explanatory diagram showing an example of a SAR satellite imaging a structure.

The imaging conditions for observation 1 and observation 2 shown in FIG. 2 are different. As a result, an amount of phase change due to the height of the structure by observation 1 is different from an amount of phase change due to the height of the structure by observation 2. Therefore, in this case, phases of the observed SAR image are different even when the target of the observation is observed under the steady state.

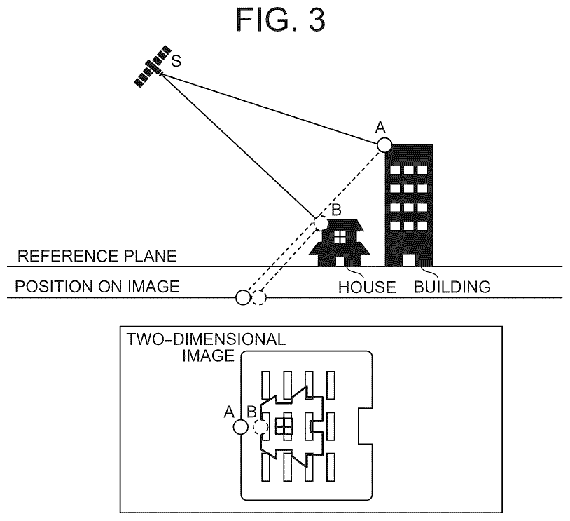

There is intensity of overlapping structures as another reason why different imaging conditions result in different observed SAR images, even when the target of observation is observed under the steady state. FIG. 3 is an explanatory diagram showing an example of layover phenomenon that occurs in a SAR image.

As shown in FIG. 3, when distance SA<distance SB, the position A of the building and the position B of the house are reversed on the image. The reversal of positions is the layover phenomenon.

When a SAR satellite takes an image of an area that includes a building and a house under the condition that causes a layover phenomenon, a two-dimensional image (SAR image) in which the building and the house overlap is taken as illustrated in FIG. 3. The area where the building and house overlap in the two-dimensional image illustrated in FIG. 3 is a layover area where signals received from multiple reflectors overlap each other. Since the information of multiple structures overlaps, it is difficult to extract the information of individual structures from the layover area.

In addition, in the layover area, the phase of the SAR image acquired for each observation also depends on the intensity of the overlapping structures. Since different imaging conditions result in different overlapping structures, the phases of the observed SAR images are different even if there is no change in the steady state of the target of the observation.

Due to the above two causes, SAR images acquired in different observations are different even when the SAR satellite observes an area under the steady state. In other words, the intensity and phase of the pixel in the SAR image that constitute a permanently existing object, such as a structure, depends on the condition under which the SAR image was taken.

Due to the fact that each of SAR images of the steady state area acquired for each observation is different from each other, it is difficult to estimate a complex image representing the steady state consistent with the imaging condition of the SAR image to be analyzed.

When a complex image with consistent the imaging condition (a complex image representing the steady state) cannot be estimated, it is difficult to detect change in the SAR image to be analyzed from the complex image using the coherent change detection technique that uses phase information. In particular, in areas where tall man-made structures are forested such as in an urban area, the layover phenomenon peculiar to SAR images is likely to occur. This makes it more difficult to estimate a complex image that represents the steady state consistent with the imaging condition.

As a method to acquire correlation using phase information other than a coherence value, for example, there is a method to extract phase information from SAR images as real number values and acquire correlation using the extracted real number values.

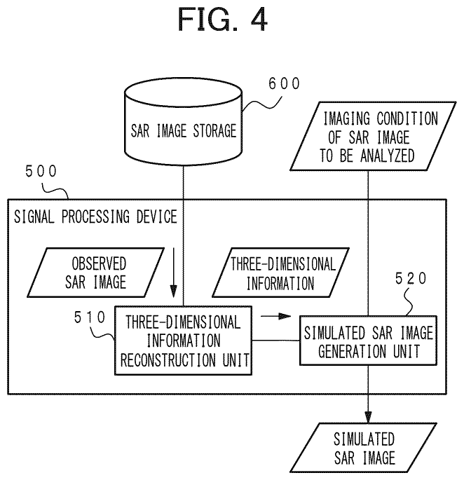

Next, a reference example corresponding to the premise of the present invention will be explained. FIG. 4 is a block diagram showing a configuration example of the signal processing device as a reference example.

The signal processing device 500 shown in FIG. 4 generates a simulated SAR image from multiple observed SAR images stored in a SAR image storage 600.

A simulated SAR image means a complex image (a complex image showing a steady state) suitable for an imaging condition of a SAR image to be analyzed. Specifically, a simulated SAR image is a two-dimensional image in which a three-dimensional information of a reconstructed area to be analyzed is simulated by information of intensity and a phase. Here, the intensity and the phase are intensity and a phase that would be expected to be observed when the image were taken under the same imaging condition as an imaging condition for the SAR image to be analyzed. In other words, “a complex image (a complex image showing a steady state) suitable for the imaging condition of a SAR image to be analyzed” means a complex image that can be regarded as having been taken under the same imaging condition as the imaging condition of the SAR image to be analyzed, i.e., the imaging condition of the observed SAR image. The three-dimensional information is represented by data that has information on intensity and a phase at three-dimensional positions in the steady state.

The SAR image to be analyzed is a SAR image to which change detection is applied. The SAR image to be analyzed is obtained by photographing it with a SAR satellite. Therefore, the simulated SAR image is a complex image showing the steady state suitable for the imaging condition of the SAR image to be analyzed.

As shown in FIG. 4, the signal processing device 500 includes a three-dimensional information reconstruction unit 510 and a simulated SAR image generation unit 520. As shown in FIG. 4, the signal processing device 500 inputs the observed SAR image from the SAR image storage 600.

When the three-dimensional information reconstruction unit 510 is included in a device other than the signal processing device 500, the signal processing device 500 includes only the simulated SAR image generation unit 520.

The SAR image storage 600 stores multiple observed SAR images. The SAR image storage 600 may be included in the signal processing device 500.

Multiple observed SAR images stored in the SAR image storage 600 are input to the three-dimensional information reconstruction unit 510. The input observed SAR images are complex images that have information on intensity and a phase of an irradiated microwave for each pixel. The observed SAR images also contain information on the imaging conditions, such as the position of the SAR satellite at the time of observation, the coordinates of the area to be analyzed, and the resolution. In addition, the three-dimensional information reconstruction unit 510 may be input not only observed SAR images obtained by observing a steady state, but also observed SAR images taken when there is a change from the steady state in the area to be analyzed.

The three-dimensional information reconstruction unit 510 has a function of reconstructing and outputting three-dimensional information (data having intensity information and phase information at each of the three-dimensional positions in a steady state) of the area to be analyzed. The three-dimensional information output by the three-dimensional information reconstruction unit 510 may be a three-dimensional complex reflectivity distribution having intensity information and phase information. The three-dimensional information may be three-dimensional point cloud data, which is a set of points having the intensity information and phase information. The three-dimensional information may have information such as temperature, displacement, etc. in addition to intensity information and phase information.

There is SAR tomography as a method of reconstructing three-dimensional information. SAR tomography is a technique that uses multiple observed SAR images to estimate a complex reflectivity distribution in an elevation direction for each pixel. The elevation direction can be defined, for example, as a direction perpendicular to an azimuth-range plane (a plane formed by the travel direction of the SAR satellite and the sight direction).

In other words, the three-dimensional information is information of each point in a three-dimensional space with azimuth, range, and elevation directions. Each point has information on intensity (estimated value of intensity) and a phase (estimated value of phase).

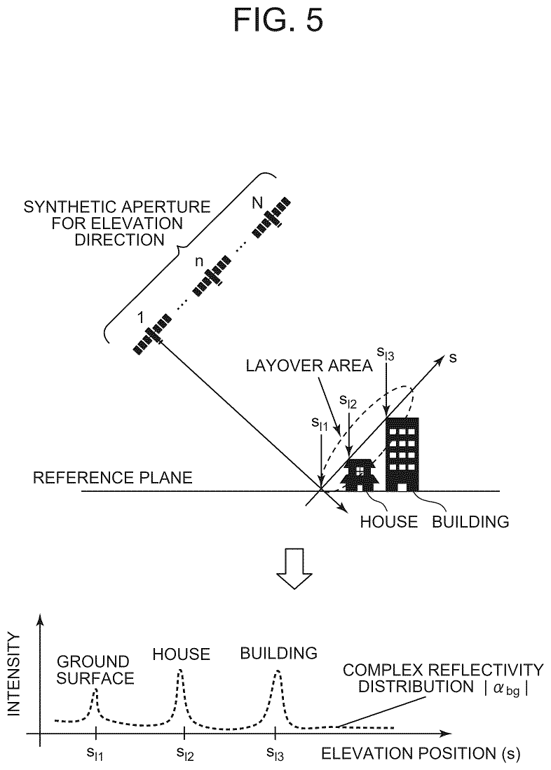

FIG. 5 is an explanatory diagram showing an example of a method of estimating a complex reflectivity distribution at a pixel corresponding to an azimuth-range position (x^{→}) by using SAR tomography.

The symbol “→” which is used in this description should originally appear directly above the immediately preceding character, but due to limitations in notation, it appears immediately after the character.

In FIG. 5, s represents the elevation direction. The plane perpendicular to the direction s in FIG. 5 represents the azimuth-range plane. The azimuth-range position (x^{→}) is the intersection of the axis indicating the elevation direction and the axis indicating the satellite line of sight direction in FIG. 5.

The three-dimensional information reconstruction unit 510 estimates a complex reflectivity distribution for each pixel, which indicates a height of a structure, intensity, and a phase that exists permanently over the observation period, based on the multiple observed SAR images.

When SAR tomography is used in the three-dimensional information reconstruction unit 510, a three-dimensional complex reflectivity distribution is generated by combining the complex reflectivity acquired for each pixel for all pixels in the area to be analyzed.

In order to reconstruct the three-dimensional steady state using SAR tomography or other methods, multiple observed SAR images taken from slightly different orbits are used. Therefore, multiple observation SAR images are input to the three-dimensional information reconstruction unit 510.

The upper row in FIG. 5 shows the SAR satellite observations from the first to the Nth observation. N indicates the total number of observations. N is an integer greater than 1.

The first to Nth observations shown in FIG. 5 correspond to a synthetic aperture for the elevation direction. In nth (1≤n≤N) observation, a relationship expression between a received signal (a complex signal) recorded in the pixel corresponding to the azimuth-range position (x^{→}) and a complex reflectivity distribution at the pixel is expressed by the following equation (1), for example.

$$\begin{matrix}[ Math . 1 ] & \\ {g}_{obs} ( x , n ) = r ( x , n ) \cdot α ( x , n ) & ( 1 )\end{matrix}$$

g_{obs}(x^{→},n) in equation (1) represents a received signal (a complex signal) recorded in the pixel corresponding to the azimuth-range position (x^{→}). r^{→}(x^{→},n) in equation (1) represents the steering vector at the pixel corresponding to the azimuth-range position (x^{→}). a^{→}(x^{→},n) in equation (1) represents a complex reflectivity distribution at the pixel corresponding to the azimuth-range position (x^{→}).

The steering vector is acquired from the imaging condition. For example, the steering vector r^{→}(x^{→},n) is expressed by the following equation (2).

$$\begin{matrix}[ Math . 2 ] & \\ r ( x , n ) = [ exp ( - 4 j π {k}_{n} {s}_{1} ) , … , exp ( - 4 j π {k}_{n} {s}_{L} ) ] ∈ {ℂ}^{1 \times L} & ( 2 )\end{matrix}$$

kₙ in equation (2) represents a phase-to-elevation conversion coefficient (a coefficient that converts between phase and elevation). s₁(1=1, . . . , L) in equation (2) represents a position in the elevation direction. The steering vector may be expressed by an equation other than equation (2). For example, a steering vector that takes into account influence of temperature and displacement may be used. j in equation (2) represents an imaginary unit. π in equation (2) represents the circle ratio. Exp represents the exponential function whose base is the Napier's constant. C represents a complex number.

The relationship expression as equation (2) is defined for every first to Nth observation. The three-dimensional information reconstruction unit 510 solves the optimization problem using multiple observation data (received signals) and steering vectors to acquire a complex reflectivity distribution α_{bg}^{→}(x^{→}) of the permanently existing structure.

Specifically, the three-dimensional information reconstruction unit 910 acquires a complex reflectivity distribution α_{bg}^{→}(x^{→}) of a structure by determining a complex reflectivity distribution so that N times observation data obtained when the area containing the structure, etc. are taken and the N times steering vectors are congruent.

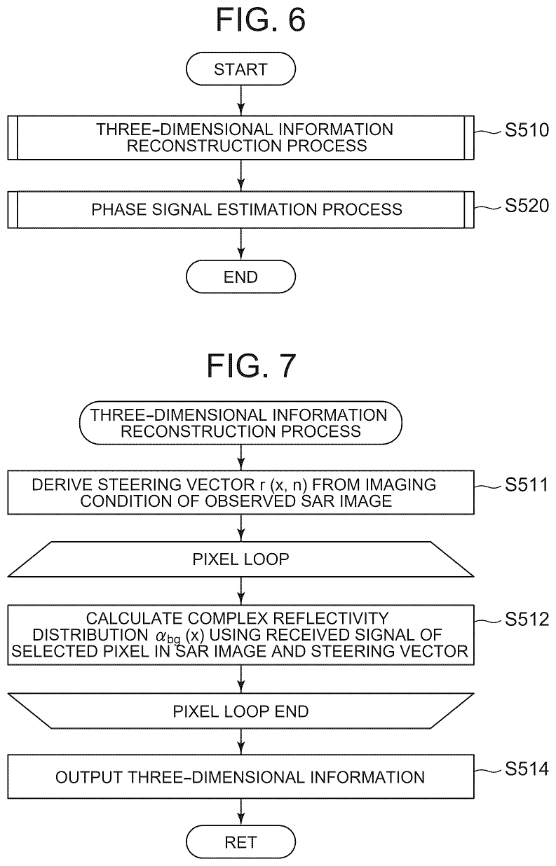

The bottom row in FIG. 5 shows an example of the absolute value |α_{bg}| of the complex reflectivity distribution α_{bg}^{→}(x^{→}) of the permanently existing structure at the pixel corresponding to the azimuth-range position (x^{→}) acquired by the three-dimensional information reconstruction unit 510. The absolute value |α_{bg}| corresponds to the intensity on the vertical axis shown in the bottom row of FIG. 5. The horizontal axis shown in the bottom row of FIG. 6 shows the elevation position.

The complex reflectivity distribution α_{bg}^{→}(x^{→}) shown in FIG. 5 presents large values at elevation positions of s₁₁ (ground surface), s₁₂ (house), and s₁₃ (building). The received signal at position x^{→} is the overlapping signal of the complex reflectivities at elevation positions of s₁₁, S₁₂ and s₁₃. More precisely, the received signal at position x^{→} corresponds to the result of the Fourier transform of the complex reflectivity distribution in the elevation direction.

When the three-dimensional information reconstruction unit 510 uses SAR tomography, the three-dimensional information reconstruction unit 510 generates a three-dimensional complex reflectivity distribution by combining the complex reflectivity distribution for each pixel for all pixels in the area to be analyzed. Then, the three-dimensional information reconstruction unit 510 outputs the three-dimensional complex reflectivity distribution as three-dimensional information. Instead of generating a three-dimensional complex reflectivity distribution, the three-dimensional information reconstruction unit 510 may generate three-dimensional point cloud data which is a set of points with information on the position of a reflector, intensity, and a phase.

The three-dimensional information reconstructed by the three-dimensional information reconstruction unit 510 is input to the simulated SAR image generation unit 520.

The imaging conditions of one or more SAR images to be analyzed are also input to the simulated SAR image generation unit 520. The one or more SAR images to be analyzed are one or more observed SAR images selected from multiple observed SAR images stored in the SAR image storage 600, for example. Hereinafter, multiple observed SAR images are referred to as a group of observed SAR images. In other words, a group of observed SAR images includes multiple observed SAR images.

The one or more SAR images to be analyzed may be one or more newly obtained observed SAR images. The multiple SAR images to be analyzed may be a mixture of observed SAR images in the SAR image storage 600 and newly obtained observed SAR images.

The imaging conditions of one or more SAR images to be analyzed that are input to the simulated SAR image generation unit 520 are the imaging conditions in the observed SAR images used to reconstruct three-dimensional information in the three-dimensional information reconstruction unit 510, for example. However, they may also be the imaging conditions in one or more newly obtained observed SAR images. The imaging condition includes the position of the SAR satellite at the time of observation, the coordinates of the area to be analyzed, and the resolution. The imaging condition may be an imaging condition of the observed SAR image stored in the SAR image storage 600 or an imaging condition of a newly obtained observed SAR image.

The simulated SAR image generation unit 520 has a function of performing pseudo-observation using the reconstructed three-dimensional information (data having information on intensity and a phase at three-dimensional positions in a steady state) and the imaging conditions of one or more SAR images to be analyzed. Specifically, the simulated SAR image generation unit 520 generates a simulated SAR image, which is a complex image (a complex image showing the steady state) suitable for the imaging conditions of one or more SAR images to be analyzed. In other words, pseudo-observation means computing an image that is predicted to be taken under the same imaging condition as the imaging condition of the analyzed SAR image as described above.

The simulated SAR image generation unit 520 performs a pseudo-observation for each of the imaging conditions of one or more SAR images to be analyzed. After one or more pseudo-observations, the simulated SAR image generation unit 520 outputs a simulated SAR image corresponding to each of obtained one or more imaging conditions.

Since the signal processing device 500 uses data with intensity information and phase information at three-dimensional positions in a steady state, i.e., three-dimensional information, the signal processing device 500 can generate a simulated SAR image, which is a complex image showing a steady state that matches the imaging condition of the SAR image to be analyzed.

The three-dimensional information reconstruction unit 510 calculates three-dimensional information using a group of observed SAR images taken of an area by SAR.

The simulated SAR image generation unit 520 generates a simulated SAR image, which is a complex image showing a steady state suitable for the imaging condition of the SAR image to be analyzed, using the three-dimensional information in the steady state reconstructed using the group of observed SAR images and the imaging condition of the SAR image to be analyzed.

Next, the operation of the signal processing device 500 to generate the simulated SAR image will be explained. FIG. 6 is a flowchart showing signal processing performed by the signal processing device 500.

The three-dimensional information reconstruction unit 510 performs a three-dimensional information reconstruction process (step S510). The three-dimensional information reconstruction process is a process to reconstruct three-dimensional information of an area to be analyzed based on the group of observed SAR images.

Next, the simulated SAR image generation unit 520 in the signal processing device 500 performs a simulated SAR image generation process (step S520). The simulated SAR image generation process is a process to generate one or more simulated SAR images based on imaging conditions of one or more SAR images to be analyzed and the reconstructed three-dimensional information. The simulated SAR image is an image in which a simulated received signal is recorded when observed under the same imaging condition as it of the SAR image to be analyzed.

After executing the simulated SAR image generation process, the signal processing device 500 terminates signal processing.

Next, the three-dimensional information reconstruction process shown in FIG. 6 will be explained with reference to FIG. 7. FIG. 7 is a flowchart showing a three-dimensional information reconstruction process performed by the three-dimensional information reconstruction unit 510.

First, the three-dimensional information reconstruction unit 510 derives the steering vector r^{→}(x^{→}, n) from the imaging conditions of respective observed SAR images in the group of observed SAR images (step S511).

Next, the three-dimensional information reconstruction unit 510 then repeatedly performs a process of calculating the complex reflectivity distribution for each of the multiple pixels.

Specifically, the three-dimensional information reconstruction unit 510 selects one pixel for which the complex reflectivity distribution has not yet been calculated from among pixels in the group of observed SAR images. The selected pixel corresponds to the selected position in the observed SAR image.

Then, the three-dimensional information reconstruction unit 510 calculates a complex reflectivity distribution α_{bg}(x^{→}) using the received signal of the selected pixel (selected position) in the group of observed SAR images and the steering vector for each of the observed SAR images (step S512). In step S512, the complex reflectivity distribution α_{bg}(x^{→}) of the pixel corresponding to position x^{→} is calculated.

The three-dimensional information reconstruction unit 510 repeats the process of step S512 until the complex reflectivity distribution for all pixels in the group of observed SAR images is calculated. In other words, the three-dimensional information reconstruction unit 510 performs pixel loop processing. When the complex reflectivity distribution for all pixels in the group of observed SAR images is calculated, the three-dimensional information reconstruction unit 510 exits the pixel loop. When exiting the pixel loop, the three-dimensional information of the target area is reconstructed.

After exiting the pixel loop, the three-dimensional information reconstruction unit 510 outputs the calculated three-dimensional complex reflectivity distribution as data having information on intensity and a phase at three-dimensional positions in a steady state, that is, as three-dimensional information (step S514). The output three-dimensional information may be a three-dimensional complex reflectivity distribution as described above, or it may be three-dimensional point cloud data which is a set of points having intensity information and phase information.

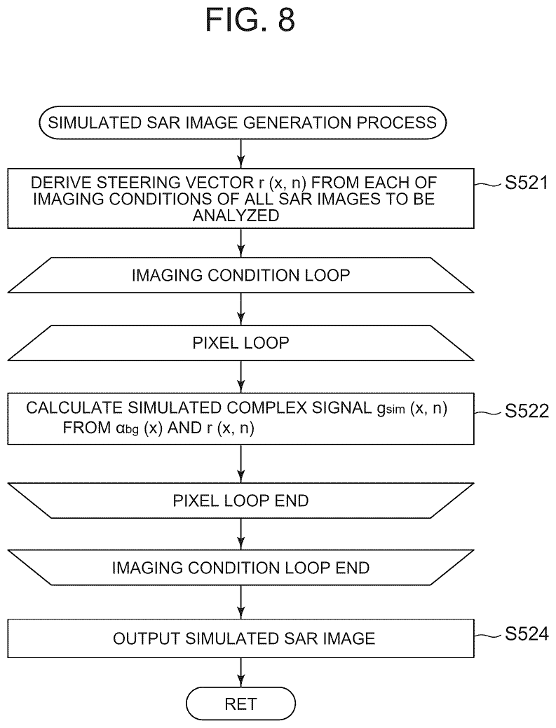

Next, the simulated SAR image generation process shown in FIG. 6 will be explained with reference to FIG. 8. FIG. 8 is a flowchart showing a simulated SAR image generation process performed by the simulated SAR image generation unit 520.

First, the simulated SAR image generation unit 520 derives the steering vector r^{→}(x^{→},n) from each of the imaging conditions of all input SAR images to be analyzed (step S521).

Next, the simulated SAR image generation unit 520 repeatedly executes the process of calculating simulated complex signals and the reliability of the simulated complex signals for each of the imaging conditions of the SAR image to be analyzed. Namely, the simulated SAR image generation unit 520 performs the imaging condition loop processing.

Specifically, in the imaging condition loop processing, the simulated SAR image generation unit 520 selects one imaging condition that has not yet been used for the phase signal estimation process from among imaging conditions of the SAR image to be analyzed.

The simulated SAR image generation unit 520 repeats the process of step S522 until the simulated complex signal for all pixels in the group of observed SAR images corresponding to the selected imaging condition is calculated. Namely, the simulated SAR image generation unit 520 performs pixel loop processing. When the simulated complex signals for all the pixels in the group of observed SAR images have been calculated, the simulated SAR image generation unit 520 exits the pixel loop. When the simulated SAR image generation unit 520 exits the pixel loop, the simulated complex signals for all pixels in the observed SAR image corresponding to the selected imaging condition have been calculated. In other words, the simulated SAR image corresponding to the selected imaging condition has been generated.

Specifically, in the pixel loop, the simulated SAR image generation unit 520 selects one pixel for which a simulated complex signal has not yet been calculated from among pixels in the group of observed SAR images corresponding to the selected imaging condition.

The simulated SAR image generation unit 520 calculates a simulated complex signal gₛᵢₘ (x^{→}, n) at position x^{→} corresponding to the selected pixel using the input complex reflectivity distribution α_{bg}(x^{→}) and the steering vector r^{→}(x^{→}, n) corresponding to the selected imaging condition (step S522). The simulated SAR image generation unit 520 calculates the simulated complex signal according to equation (3), for example.

$$\begin{matrix}[ Math . 3 ] & \\ {g}_{sim} ( x , n ) = r ( x , n ) \cdot {α}_{bg} ( x ) & ( 3 )\end{matrix}$$

The simulated SAR image generation unit 520 may calculate the simulated complex signal according to an equation other than equation (3).

After the pixel loop processing is performed with respect to all imaging conditions, the simulated SAR image generation unit 520 exits the imaging condition loop. When the simulated SAR image generation unit 520 exits the imaging condition loop, a simulated SAR image of the target area is generated for each of the imaging conditions of all input SAR images to be analyzed.

After exiting the imaging condition loop, the simulated SAR image generation unit 520 outputs a simulated SAR image which is a complex image (a complex image showing a steady state) suitable for the imaging condition of the input SAR image to be analyzed (step S524). When there are multiple imaging conditions, there are also multiple simulated SAR images to be output.

### Explanation of the Effect of the Reference Example

The three-dimensional information reconstruction unit 510 in the signal processing device 500 reconstructs data having information on intensity and a phase at each three-dimensional position in a steady state in the area to be analyzed, i.e., three-dimensional information, based on a group of observed SAR images stored in the SAR image storage 600. In addition, the simulated SAR image generation unit 520 generates one or more simulated SAR images based on the imaging conditions of one or more SAR images to be analyzed and the reconstructed three-dimensional information.

One of the advantages of using SAR tomography is that a simulated complex signal that shows the intensity and phase of each overlapping reflector is recorded in the simulated SAR image. In general, it is difficult to generate a simulated complex signal that accurately indicates the intensity and a phase of each overlapping reflector, even using a DEM (Digital Elevation Model), etc. However, the signal processing device 500 in the above reference example can generate a complex image showing a steady state suitable for SAR image analysis. As a result, users who perform coherent change detection using the generated simulated SAR image can robustly detect changes even in the layover area. In other words, when detecting changes from the steady state in the SAR image to be analyzed, changes can be detected with high accuracy.

In the above reference example, the three-dimensional information reconstruction unit 510 used SAR tomography as means of calculating three-dimensional information. However, the three-dimensional information reconstruction unit 510 may use other means than SAR tomography that can reproduce the intensity and a phase as means for calculating three-dimensional information.

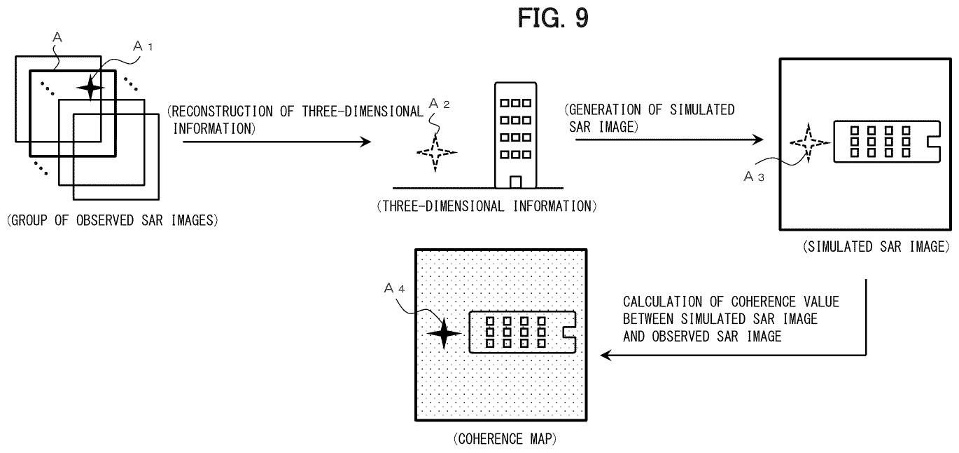

FIG. 9 is an explanatory diagram for explaining a change detection process when a SAR image showing a steady state includes information other than the steady state. As an example of a SAR image, take the observed SAR image stored in the SAR image storage 600. Suppose that there is an observed SAR image A that contains information A₁ other than the steady state in the group of observed SAR images shown in FIG. 9.

In the above reference example, the three-dimensional information reconstruction unit 510 reconstructs three-dimensional information of the area to be analyzed based on a group of observed SAR images. The reconstructed three-dimensional information is affected by information A₂ other than a steady state caused by information A₁. As a result, the simulated SAR image generated by the simulated SAR image generation unit 520 reflects information A₃ other than the steady state caused by information A₂.

As data used for change detection, coherence values obtained from simulated SAR images and observed SAR images are used as an example. FIG. 9 shows a cross-correlation image between the simulated SAR image and the observed SAR image, i.e., a coherence map. In the coherence map, the coherence value of the shaded area is large. However, the coherence value of the area A₄ is small. The reason for the low coherence in the area A₄ is that it reflects information A₃ other than the steady state. When the change detection process is performed using the coherence map shown in FIG. 9, false detection of changes may occur.

Compared to the signal processing device in the above reference example, the signal processing devices in the following example embodiments can generate a complex image showing a steady state more suitable for SAR image analysis. As a result, changes can be detected more accurately when detecting changes from the steady state in the SAR image to be analyzed.

Hereinafter, example embodiments of the present invention will be explained with reference to the drawings.

### Example Embodiment 1

### First Aspect of the First Example Embodiment

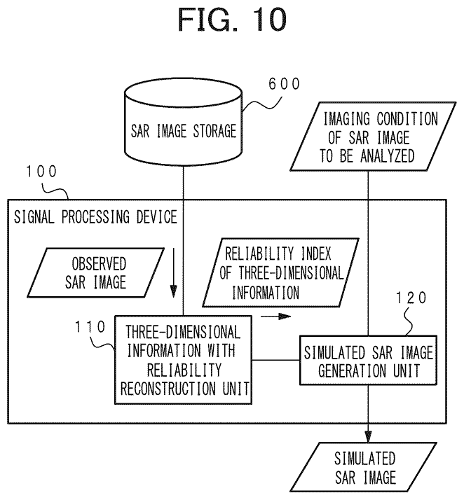

FIG. 10 is a block diagram showing a configuration example of the signal processing device of the first aspect of the first example embodiment.

The signal processing device 100 shown in FIG. 10 includes a three-dimensional information with reliability reconstruction unit 110 and a simulated SAR image generation unit 120. Multiple observed SAR images stored in the SAR image storage 600 are input to the three-dimensional information with reliability reconstruction unit 110. As in the reference example, an observed SAR image taken when there is a change from the steady state may be input to the three-dimensional information with reliability reconstruction unit 110.

When the three-dimensional information with reliability reconstruction unit 110 is included in a device other than the signal processing device 100, the signal processing device 100 includes only the simulated SAR image generation unit 120.

Similar to the three-dimensional information reconstruction unit 510 shown in FIG. 4, the three-dimensional information with reliability reconstruction unit 110 reconstructs and outputs three-dimensional information of the area to be analyzed. As in the reference example, the three-dimensional information may have information such as temperature and displacement in addition to the intensity and phase information.

In addition to the function of generating three-dimensional information, the three-dimensional information with reliability reconstruction unit 110 has a function of calculating an index value indicating reliability of the three-dimensional information (hereinafter referred to as a reliability index value) and outputting the reliability index value.

An example of how the reliability index value is calculated will be explained.

The observed SAR image is an image in which the received signal is recorded. The three-dimensional information with reliability reconstruction unit 110 calculates a reliability index value by evaluating the discrepancy between the received signal and a received signal (predicted signal) predicted from the reconstructed three-dimensional information for each of the intensity and the phase. The three-dimensional information reconstruction with reliability unit 110 may calculate a reliability index value by evaluating how reliable each estimate in the reconstructed three-dimensional information is among the possible values. The three-dimensional information with reliability reconstruction unit 110 may also use the evaluation of a discrepancy and the evaluation of the likelihood of the estimated values, together.

The three-dimensional information with reliability reconstruction unit 110, for example, evaluates discrepancy using a difference between the received signal and the predicted signal. When using a difference between the received signal and the predicted signal, a difference squared error, a difference of absolute values, or the like is used. When evaluating discrepancy, the three-dimensional information reconstruction with reliability unit 110 may evaluate a function in which a term expressing the complexity of the reconstructed three-dimensional information is added to the difference between the received signal and the predicted signal. In general, three-dimensional scatterers exist often sparsely, and a term generally referred to as a regularization term may be included as a term for determining that the solution is better. In particular, the L0, L1, and L2 norms can be employed as the regularization term. When evaluating discrepancy, the three-dimensional information with reliability reconstruction unit 110 may use cross-validation by making the received signal used to evaluate the difference from the predicted value different from the received signal used for three-dimensional information reconstruction, for evaluating generalization ability of the reconstructed three-dimensional information.

The three-dimensional information with reliability reconstruction unit 110 outputs, for example, parameters (a variance value, a covariance matrix, a confidence interval, etc.) of the posterior distribution of each estimate acquired by Bayesian estimation and a posterior distribution as reliability of the estimate. The three-dimensional information with reliability reconstruction unit 110 may calculate the reliability index value by evaluating a squared error or a loss function in an optimization process when reconstructing the three-dimensional information.

Similar to the simulated SAR image generation unit 520 shown in FIG. 4, the simulated SAR image generation unit 120 has a function of generating a simulated SAR image based on the reconstructed three-dimensional information input from the three-dimensional information with reliability reconstruction unit 110. The imaging conditions of one or more SAR images to be analyzed are also input to the simulated SAR image generation unit 120. As in the reference example, the simulated SAR image generation unit 120 generates a simulated SAR image, which is a complex image (a complex image showing a steady state) suitable for the imaging conditions of one or more SAR images to be analyzed.

In addition to the function of generating a simulated SAR image, the simulated SAR image generation unit 120 has a function of generating information (hereinafter referred to as reliability information), which represents the reliability of each of the generated a simulated SAR image using the reliability index value input from the three-dimensional information with reliability reconstruction unit 110.

An example of how reliability information is calculated will be explained.

The simulated SAR image generation unit 120 generates reliability information by statistical processing using the generated simulated SAR image and reliability index values. For example, the simulated SAR image generation unit 120 evaluates the reliability of the simulated SAR image using a variance or a covariance matrix of the posterior probability distribution of the acquired three-dimensional information, when the three-dimensional information with reliability reconstruction unit 110 uses Bayesian estimation.

When evaluating reliability, the simulated SAR image generation unit 120 may use a standard deviation of prediction that can be calculated for each imaging condition and each pixel in the simulated SAR image. In that case, the simulated SAR image generation unit 120 may use the standard deviation of the prediction itself as reliability information, for example. The simulated SAR image generation unit 120 may also compare the reliability information in each pixel with a predetermined threshold value to identify pixels with low reliability and use the identification result as the reliability information.

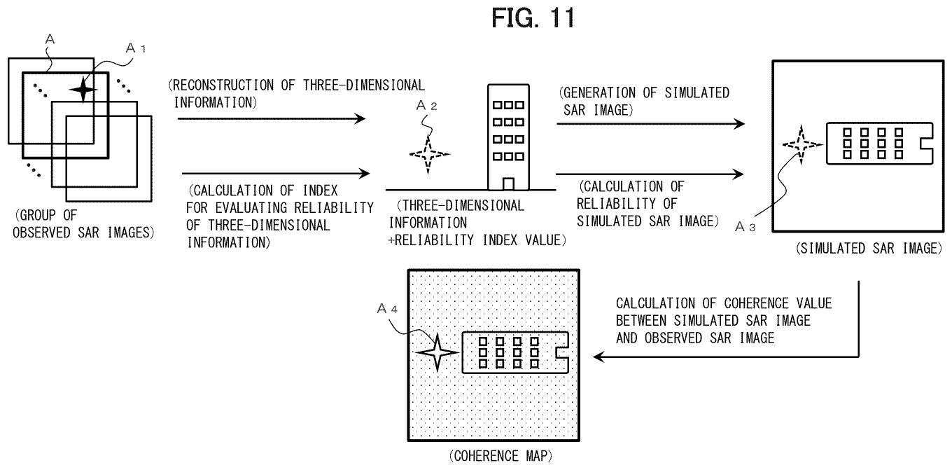

FIG. 11 is an explanatory diagram for explaining an improved change detection process when an observed SAR image showing a steady state includes information other than the steady state. FIG. 11 corresponds to an explanatory diagram for explaining the processing of the signal processing device 100 and the change detection process using the simulated SAR image generated by the signal processing device 100. Specifically, some of the processes shown in FIG. 11 correspond to the processes performed by the three-dimensional information with reliability reconstruction unit 110 and the simulated SAR image generation unit 120.

As an example of a SAR image, take an observed SAR image stored in the SAR image storage 600. Suppose that there is an observed SAR image A in the group of observed SAR images shown in FIG. 11 that contains information A₁ other than steady state. The three-dimensional information with reliability reconstruction unit 110 reconstructs a three-dimensional information of the area to be analyzed based on a group of observed SAR images. The reconstructed three-dimensional information is affected by information A₂ other than a steady state caused by the information A₁.

Furthermore, the three-dimensional information with reliability reconstruction unit 110 calculates reliability index values of the reconstructed three-dimensional information.

As mentioned above, the reconstructed three-dimensional information is affected by the information A₂ other than a steady state caused by the information A₁. As a result, the information A₃ other than the steady state caused by the information A₂ is reflected in the simulated SAR image generated by the simulated SAR image generation unit 120.

In the coherence map shown in FIG. 11, the coherence value of the shaded area is large. However, the coherence value of the area A₄ is small. In this example embodiment, since the simulated SAR image generation unit 120 generates reliability information based on the reliability index, it is possible to avoid evaluating coherence values for positions (pixels) with low reliability when the change detection process is performed. As a result, changes can be detected more accurately when detecting changes from the steady state of the SAR image to be analyzed.

The change detection process is performed by a first change detection unit 130 or a second change detection unit 140, as described below.

### Second Aspect of the First Example Embodiment

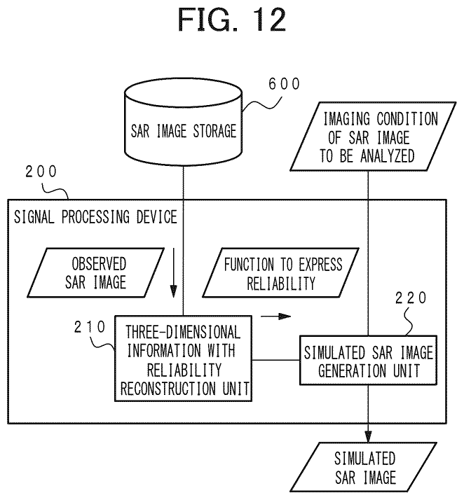

FIG. 12 is a block diagram showing other configuration example of the signal processing device of the first example embodiment.

A signal processing device 200 shown in FIG. 12 includes a three-dimensional

information with reliability estimation unit 210 and a simulated SAR image generation unit 220. Multiple observed SAR images stored in the SAR image storage 600 are input to the three-dimensional information with reliability estimation unit 210. As in the reference example, observed SAR images of cases with changes from the steady state may be input to the three-dimensional information with reliability estimation unit 210.

When the three-dimensional information with reliability estimation unit 210 is included in a device other than the signal processing device 200, the signal processing device 200 includes only the simulated SAR image generation unit 220.

The three-dimensional information with reliability estimation unit 210 has a function to calculate a function that expresses information about how reliable what values are as intensity and phase at each point (each position) in a three-dimensional space with azimuth, range, and elevation directions.

Hereinafter, the function is referred to as three-dimensional information with reliability. It should be noted that the information generated by the three-dimensional information with reliability reconstruction unit 110 shown in FIG. 10, i.e., the combination of three-dimensional information and the reliability index value, also corresponds to the three-dimensional information with reliability.

The simulated SAR image generation unit 220 has a function of the simulated SAR image generation unit 520 shown in FIG. 4. However, the above three-dimensional information with reliability is input to the simulated SAR image generation unit 220 from the three-dimensional information with reliability estimation unit 210. The imaging conditions of one or more SAR images to be analyzed are also input to the simulated SAR image generation unit 220. As in the reference example, the simulated SAR image generation unit 120 generates a simulated SAR image, which is a complex image (a complex image showing a steady state) suitable for the imaging conditions of one or more SAR images to be analyzed.

In addition to the function of generating a simulated SAR image, the simulated SAR image generation unit 220 has a function of generating reliability information for each of the generated simulated SAR images. The information (data) output by the simulated SAR image generation unit 220 is the same as information output by the simulated SAR image generation unit 120. As mentioned above, the information output by the simulated SAR image generation unit 120 is the simulated SAR image and the reliability information.

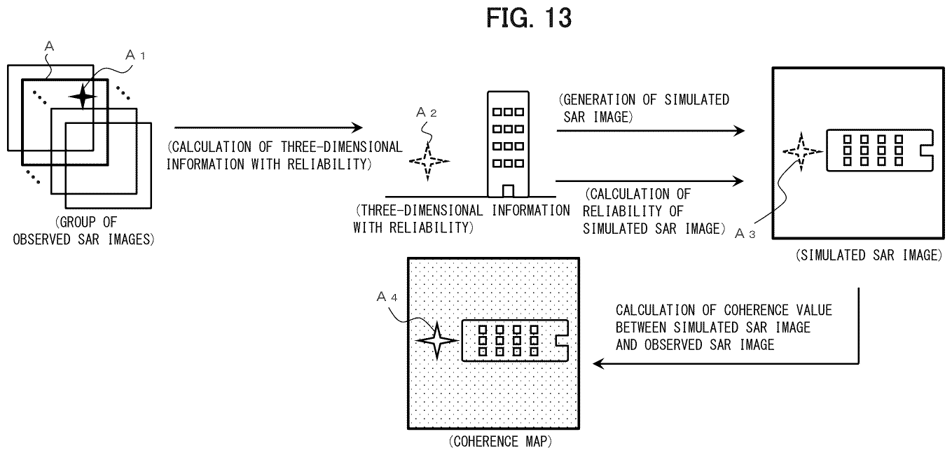

FIG. 13 is an explanatory diagram for explaining other improved change detection process when an observed SAR image showing a steady state includes information other than the steady state. FIG. 13 corresponds to an explanatory diagram of the processing of the signal processing device 200 and the change detection process using the simulated SAR image generated by the signal processing device 200. Specifically, some of the processes shown in FIG. 13 correspond to the processes performed by the three-dimensional information with reliability estimation unit 210 and the simulated SAR image generation unit 220.

As an example of a SAR image, take an observed SAR image stored in the SAR image storage 600. Suppose that there is an observed SAR image A that includes information A1 other than the steady state in the group of observed SAR images shown in FIG. 13. The three-dimensional information with reliability estimation unit 210 reconstructs the three-dimensional information of the area to be analyzed based on the group of observed SAR images. Specifically, the three-dimensional information with reliability estimation unit 210 generates three-dimensional information with reliability (a function that expresses information about how reliable what values are as intensity and phase at each point). The three-dimensional information involved in the reconstructed three-dimensional information with reliability is affected by the information A₂ other than the steady state caused by the information A₁.

Method of Calculating Three-Dimensional Information with Reliability in the Second Aspect

The three-dimensional information with reliability reconstruction unit 210 calculates the three-dimensional information with reliability using the posterior distribution, for example. In that case, the three-dimensional information with reliability reconstruction unit 210 takes the three-dimensional information with reliability for the posterior distribution itself, for example. The three-dimensional information with reliability reconstruction unit 210 may also take the three-dimensional information with reliability for parameters of the posterior distribution. The parameters of the posterior distribution include mean, mode, variance, confidence interval, etc. The three-dimensional information with reliability reconstruction unit 210 may also take the three-dimensional information with reliability for a candidate group of posterior sampled three-dimensional information (an estimate of intensity and a phase).

The reconstructed three-dimensional information is affected by information A₂ other than steady state caused by the information A₁. As a result, the simulated SAR image generated by the simulated SAR image generation unit 220 reflects information A₃ other than steady state caused by the information A₂.

In the coherence map shown in FIG. 13, the coherence value of the shaded area is large. However, the coherence value of area A₄ is small. In this example embodiment, since the simulated SAR image generation unit 220 generates the reliability information from the three-dimensional information with reliability estimation unit 210, it is possible to avoid evaluating coherence values for positions (pixels) with low reliability when the change detection process is performed. As a result, changes can be detected more accurately when detecting changes from the steady state of the SAR image to be analyzed.

The change detection process is performed by the first change detection unit 130 or the second change detection unit 140, as described below.

### The Operation of the First Aspect of the First Example Embodiment

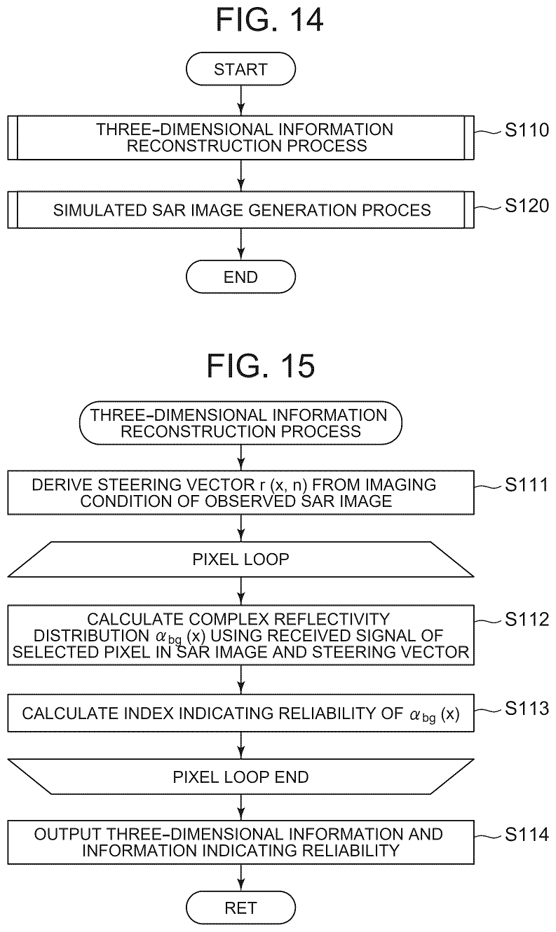

Hereinafter, the signal processing by the signal processing device 100 in this example embodiment will be described with reference to FIG. 14. FIG. 14 is a flowchart showing signal processing performed by the signal processing device 100 of the first aspect shown in FIG. 10.

In the signal processing device 100, the three-dimensional information with reliability reconstruction unit 110 performs the three-dimensional information reconstruction process (step S110). The three-dimensional information reconstruction process is a process to reconstruct three-dimensional information of an area to be analyzed based on an accumulated group of observed SAR images. In step S110, the three-dimensional information with reliability reconstruction unit 110 calculates a reliability index value of the reconstructed three-dimensional information. The method of calculating the reliability index value has already been explained.

Next, the simulated SAR image generation unit 120 performs the simulated SAR image generation process (step S120). The simulated SAR image generation process is a process to generate one or more simulated SAR images based on the imaging conditions of one or more SAR images to be analyzed and the reconstructed three-dimensional information. As described above, in the simulated SAR image generation process, the simulated SAR image generation unit 120 generates a simulated SAR image, which is an image in which a simulated received signal is recorded when observed under the same imaging conditions as those of the respective SAR images to be analyzed.

In step S120, the simulated SAR image generation unit 120 also performs the process of generating reliability information. The method of calculating the reliability information has already been described.

Next, the three-dimensional information reconstruction process (step S110) shown in FIG. 14 will be explained with reference to FIG. 15. FIG. 15 is a flowchart showing the three-dimensional information reconstruction process performed by the three-dimensional information with reliability reconstruction unit 110.

First, the three-dimensional information with reliability reconstruction unit 110 derives the steering vector r^{→}(x^{→}, n) from the imaging conditions of each observed SAR image in the group of observed SAR images (step S111).

Next, the three-dimensional information with reliability reconstruction unit 110 repeatedly performs the processes of calculating the complex reflectivity distribution and the reliability index value for each of the multiple pixels.

Specifically, the three-dimensional information with reliability reconstruction unit 110 selects one pixel for which the phase signal has not yet been calculated from among pixels in the group of observed SAR images. The selected pixel corresponds to the selected position in the observed SAR image.

Then, the three-dimensional information with reliability reconstruction unit 110 calculates a complex reflectivity distribution α_{bg}(x^{→}) using the received signal of the selected pixel (selected position) in the group of observed SAR images and the steering vector for each of the observed SAR images (step S112). In step S112, the complex reflectivity distribution α_{bg}(x^{→}) corresponding to a pixel corresponding to the position x^{→} is calculated.

The processes of steps S111 and S112 are the same as the processes of steps S511 and S512 in the reference example shown in FIG. 7.

Furthermore, the three-dimensional information with reliability reconstruction unit 110 calculates the complex reflectivity distribution α_{bg}(x^{→}) at the pixel being handled using the calculation method described above (step S113). In other words, the three-dimensional information with reliability reconstruction unit 110 calculates the reliability index value of the reconstructed three-dimensional information.

The three-dimensional information with reliability reconstruction unit 110 repeatedly performs steps S112 and S113 until the complex reflectivity distribution for all pixels in the group of observed SAR images is calculated and the reliability index values for all pixels are calculated. In other words, the three-dimensional information with reliability reconstruction unit 110 performs pixel loop processing. When the complex reflectivity distribution and reliability index values for all pixels in the group of observed SAR images are calculated, the three-dimensional information with reliability reconstruction unit 110 exits the pixel loop. When the three-dimensional information with reliability reconstruction unit 110 exits the pixel loop, the three-dimensional information of the target area has been reconstructed and the reliability index values have been calculated.

After exiting the pixel loop, the three-dimensional information with reliability reconstruction unit 110 outputs the calculated three-dimensional complex reflectivity distribution as data with information on intensity and a phase at three-dimensional positions in steady state, i.e., as three-dimensional information, and the calculated reliability index value as three-dimensional information (step S114). The reliability index value to be output is the combined reliability index value for each pixel calculated in step S113.

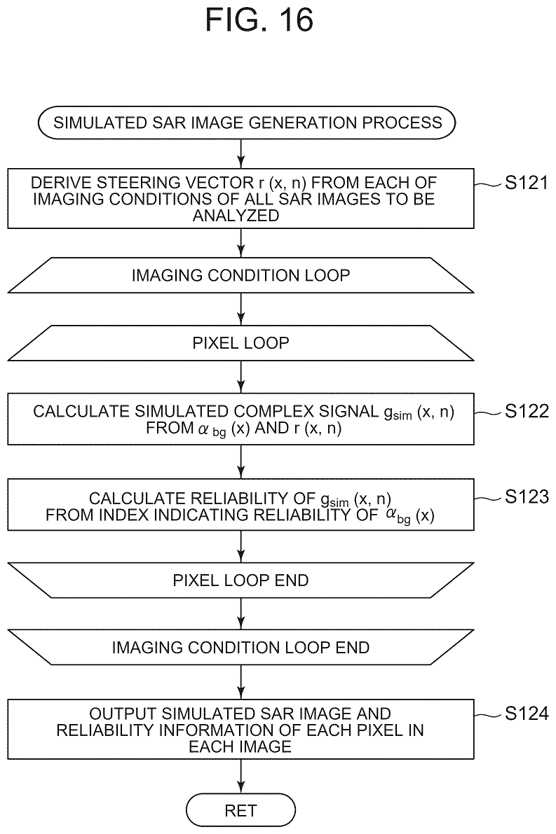

Next, the simulated SAR image generation process (step S120) shown in FIG. 14 will be explained with reference to FIG. 16. FIG. 16 is a flowchart showing a simulated SAR image generation process performed by the simulated SAR image generation unit 120.

First, the simulated SAR image generation unit 120 derives a steering vector r^{→}(x^{→}, n) from each of the imaging conditions of all input SAR images to be analyzed (step S121). The process of step S121 is the same as the process of step S521 in the reference example shown in FIG. 8.

Next, the simulated SAR image generation unit 120 repeatedly performs the processes of calculating the simulated complex signal and calculating reliability of the simulated complex signal for each of the imaging conditions of the SAR image to be analyzed. In other words, the simulated SAR image generation unit 120 performs imaging condition loop processing.

Specifically, in the imaging condition loop processing, the simulated SAR image generation unit 120 selects one of the imaging conditions of the SAR image to be analyzed that has not yet been used to generate the simulated SAR image from among imaging conditions of SAR images to be analyzed.

Then, the simulated SAR image generation unit 120 performs pixel loop processing. In the pixel loop processing, the simulated SAR image generation unit 120 selects one pixel among the pixels in the group of observed SAR images corresponding to the selected imaging condition for which the simulated complex signal has not yet been calculated.

The simulated SAR image generation unit 120 repeats the process of steps S122 and S123 until the simulated complex signal and reliability information for all pixels in the group of observed SAR images corresponding to the selected imaging conditions are calculated. When the simulated complex signal and the reliability of the simulated complex signal for all pixels in the observed SAR images corresponding to the selected imaging conditions are calculated, the simulated SAR image generation unit 120 exits the pixel loop. When the simulated SAR image generation unit 120 exits the pixel loop, the simulated complex signal and the reliability of the simulated complex signal for all pixels in the observed SAR image corresponding to the selected imaging condition are calculated. In other words, the simulated SAR image and the reliability information representing the reliability of the simulated SAR image are calculated.

In step S122, the simulated SAR image generation unit 120 calculates a simulated complex signal gₛᵢₘ(x^{→}, n) at position x^{→} corresponding to the selected pixel using the input complex reflectivity distribution α_{bg}(x^{→}) and the steering vector r^{→}(x^{→}, n) corresponding to the selected imaging condition. The simulated SAR image generation unit 120, for example, calculates the simulated complex signal according to the above equation (3). The simulated SAR image generation unit 120 may calculate the simulated complex signal according to an equation other than Equation (3).

The process of step S122 is the same as the process of step S522 in the reference example shown in FIG. 8.

Furthermore, the simulated SAR image generation unit 120 calculates information on the reliability of the simulated SAR image (reliability information) by statistical processing using a reliability index indicating the reliability of the reconstructed three-dimensional information and the generated simulated SAR image (step S123). The method of calculating the reliability information has already been described.

The simulated SAR image generation unit 120 exits the imaging condition loop when the pixel loop processing is performed for all imaging conditions. When the simulated SAR image generation unit 120 exits the imaging condition loop, a simulated SAR image of the target area and the reliability information of each simulated SAR image are generated corresponding to each of the imaging conditions of all the SAR images to be analyzed that have been input.

After exiting the imaging condition loop, the simulated SAR image generation unit 120 outputs a simulated SAR image, which is a complex image (a complex image showing a steady state) suitable for the imaging conditions of the input SAR image to be analyzed, and the reliability information at each pixel (step S124). When there are multiple imaging conditions, there are also multiple simulated SAR images and reliability information to be output.

### Explanation of the Effect of the First Aspect of the First Example Embodiment

In this example embodiment, the signal processing device 100 outputs reliability information indicating the reliability of the simulated SAR image in addition to the simulated SAR image. As a result, compared to the reference example, the accuracy of change detection is improved by preventing false detection caused by the inclusion of information other than steady state information.

### Operation of the Second Aspect of the First Example Embodiment

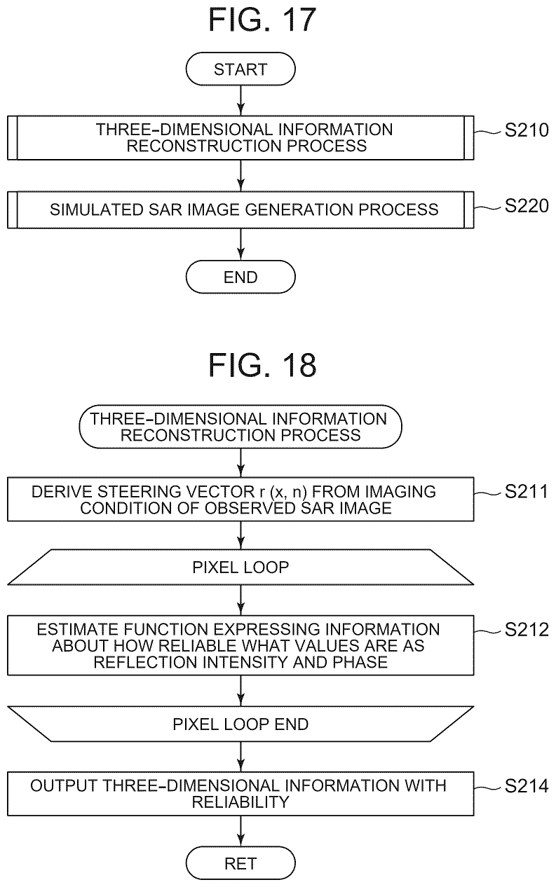

Hereinafter, the signal processing by the signal processing device 200 of the other aspect of this example embodiment is described below with reference to FIG. 17. FIG. 17 is a flowchart showing signal processing in the second aspect performed by the signal processing device 200 shown in FIG. 12.

In the signal processing device 200, the three-dimensional information with reliability estimation unit 210 performs the three-dimensional information reconstruction process using the calculation method already described (step S210). As described above, the three-dimensional information reconstruction process is a process to calculate a function that expresses information about how reliable what values are as intensity and a phase at each point (each position) in a three-dimensional space with azimuth, range, and elevation directions.

The three-dimensional information with reliability includes the three-dimensional information and the information indicating the reliability of the three-dimensional information. In other words, the three-dimensional information with reliability essentially includes the three-dimensional information and the information indicating the reliability of the three-dimensional information.

Next, the simulated SAR image generation unit 220 performs the simulated SAR image generation process (step S220). The simulated SAR image generation process is a process to generate one or more simulated SAR images based on the imaging conditions of one or more SAR images to be analyzed and the reconstructed three-dimensional information (substantially included in the three-dimensional information with reliability). Specifically, the simulated SAR image generation unit 220 selects or generates a likely simulated complex signal.

Next, the three-dimensional information reconstruction process (step S210) shown in FIG. 17 will be explained with reference to FIG. 18. FIG. 18 is a flowchart showing a three-dimensional information reconstruction process performed by the three-dimensional information with reliability estimation unit 210.

First, the three-dimensional information with reliability estimation unit 210 derives the steering vector r^{→}(x^{→}, n) from the imaging conditions of each observed SAR image in the group of observed SAR images (step S211). The processing of step S211 is the same as the processing of step S511 in the reference example shown in FIG. 7.

Next, the three-dimensional information with reliability estimation unit 210 repeatedly performs the process of calculating three-dimensional information with reliability for each of the multiple pixels.

Specifically, the three-dimensional information with reliability estimation unit 210 selects one pixel for which the complex reflectivity distribution has not yet been calculated from among pixels in the group of observed SAR images. The selected pixel corresponds to the selected position in the observed SAR image.

Then, the three-dimensional information with reliability estimation unit 210 estimates a function that expresses information about how reliable what values are as intensity and a phase, i.e., three-dimensional information with reliability, based on the received signal of a selected pixel (a selected position) in the group of observed SAR images (step S212).

The three-dimensional information with reliability estimation unit 210 repeatedly performs the process of step S212 until the complex reflectivity distribution for all pixels in the observed SAR image group is calculated. In other words, the three-dimensional information with reliability estimation unit 210 performs pixel loop processing. When the three-dimensional information with reliability for all pixels in the group of observed SAR images is calculated, the three-dimensional information with reliability estimation unit 210 exits the pixel loop. When the three-dimensional information with reliability estimation unit 210 exits the pixel loop, the three-dimensional information with reliability for the target area has been generated.

After exiting the pixel loop, the three-dimensional information with reliability estimation unit 210 outputs the three-dimensional information with reliability (step S214).

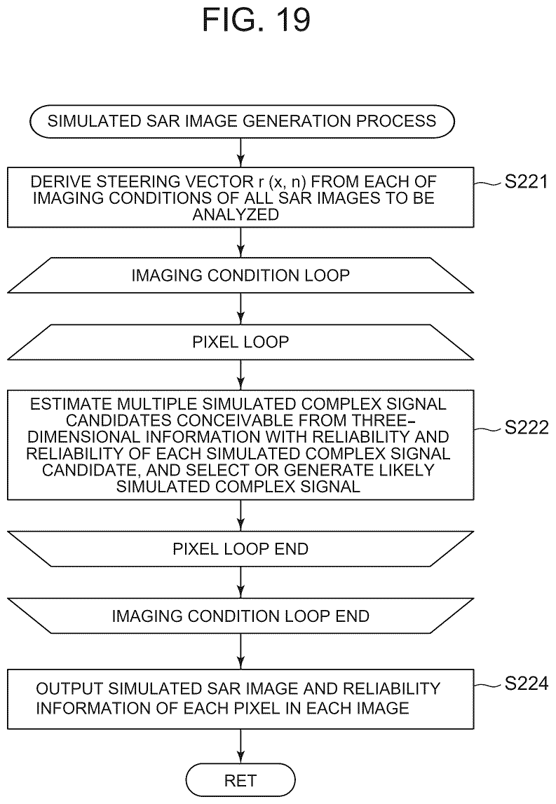

Next, the simulated SAR image generation process (step S220) shown in FIG. 17 will be explained with reference to FIG. 19. FIG. 19 is a flowchart showing a simulated SAR image generation process performed by the simulated SAR image generation unit 220.

First, the simulated SAR image generation unit 220 derives a steering vector r^{→}(x^{→}, n) from each of the imaging conditions of all input SAR images to be analyzed (step S221).

Next, the simulated SAR image generation unit 220 performs imaging condition loop processing. In the imaging condition loop processing, the simulated SAR image generation unit 220 selects one of the imaging conditions of the SAR image to be analyzed that has not yet been used to generate the simulated SAR image from among imaging conditions of SAR images to be analyzed.

Then, the simulated SAR image generation unit 220 performs pixel loop processing. In the pixel loop processing, the simulated SAR image generation unit 220 selects one pixel for which the simulated complex signal has not yet been calculated from among pixels corresponding to the selected imaging condition in the group of observed SAR images. Then, the simulated SAR image generation unit 220 estimates the multiple simulated complex signal candidates estimated from the three-dimensional information with reliability and the reliability of each simulated complex signal candidate, and performs the estimation process to select or generate a likely simulated complex signal (step S222). When the estimation process is performed for all pixels in the group of observed SAR images corresponding to the selected imaging conditions, the simulated SAR image generation unit 220 exits the pixel loop.

When the pixel loop processing is performed for all imaging conditions, the simulated SAR image generation unit 220 exits the imaging condition loop. When the simulated SAR image generation unit 220 exits, a simulated SAR image of the target area and the reliability information of each simulated SAR image are generated corresponding to each of the imaging conditions of all input SAR images to be analyzed.

This is the same as in the case of the first aspect of the first example embodiment. In other words, the simulated SAR image generation unit 220 generates the same information (data) that the simulated SAR image generation unit 120 outputs.

After exiting the imaging condition loop, the simulated SAR image generation unit 220 outputs a simulated SAR image, which is a complex image (a complex image showing a steady state) suitable for the imaging conditions of the input SAR image to be analyzed, and reliability information at each pixel (step S224). When there are multiple imaging conditions, there are also multiple simulated SAR images and reliability information to be output.

### Explanation of the Effect of the Second Aspect of the First Example Embodiment

In this example embodiment, the signal processing device 200 outputs reliability information indicating the reliability of the simulated SAR image in addition to the simulated SAR image. As a result, compared to the reference example, the accuracy of change detection is improved by preventing false detection caused by the inclusion of information other than steady state information.

### Example Embodiment 2

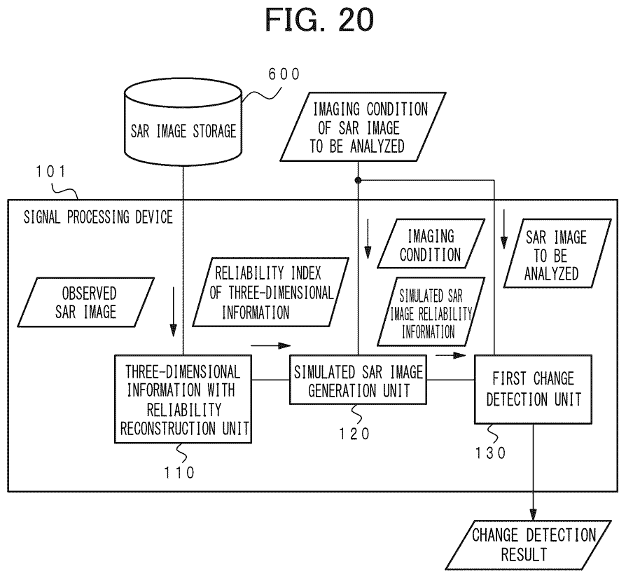

Next, the second example embodiment of the present invention will be explained with reference to the drawings. FIG. 20 is a block diagram showing a configuration example of the signal processing device of the second example embodiment of the present invention.

The signal processing device 101 shown in FIG. 20 includes a three-dimensional information with reliability reconstruction unit 110, a simulated SAR image generation unit 120, and a first change detection unit 130. As shown in FIG. 20, the signal processing device 101 inputs the observed SAR image from the SAR image storage 600.

The functions of the three-dimensional information with reliability reconstruction unit 110 and the simulated SAR image generation unit 120 in this example embodiment are the same as those of the three-dimensional information with reliability reconstruction unit 110 and the simulated SAR image generation unit 120 in the first example embodiment.

One or more SAR images to be analyzed are input to the first change detection unit 130. The SAR image to be analyzed contains a received signal indicating information on intensity and a phase. The imaging conditions of the one or more SAR images to be analyzed are input to the first change detection unit 130. The one or more imaging conditions are the same as the one or more imaging conditions input to the simulated SAR image generation unit 120. One or more simulated SAR images corresponding to each of the one or more imaging conditions are input to the first change detection unit 130 from the simulated SAR image generation unit 120. In addition, the first change detection unit 130 receives reliability information at each pixel from the simulated SAR image generation unit 120.

The first change detection unit 130 performs a change detection process. The change detection process is a correlation process using information on the phase of the simulated SAR image and the phase of the SAR image to be analyzed, for example. For performing the correlation process, the first change detection unit 130 has a function to output the value calculated by the correlation process as a change detection result. The first change detection unit 130 may compare the value calculated by the correlation process with a predetermined threshold value and output information (data) indicating the presence or absence of a change based on the comparison result as a change detection result.

The correlation (correlation value) represents a degree of similarity between the SAR image to be analyzed and the simulated SAR image (hereinafter referred to as “similarity”), for example. The similarity represents a distance between multiple images, as an example. The similarity may also be expressed as an index other than a distance between the images. Hereafter, similarity may be expressed as correlation.

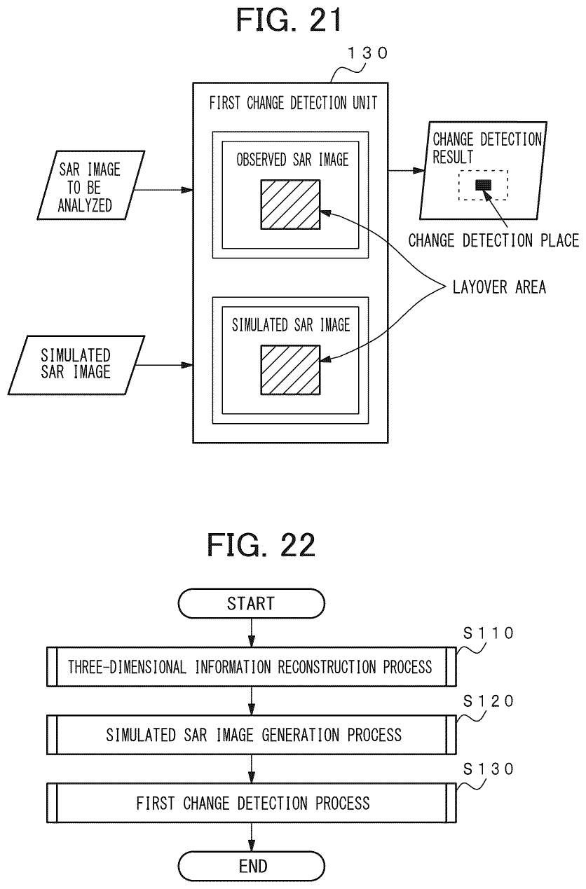

FIG. 21 is an explanatory diagram showing a specific example of the first change detection process performed by the first change detection unit 130. As described above, the three-dimensional information with reliability reconstruction unit 110 inputs observed SAR images stored in the SAR image storage 600 and reconstructs three-dimensional information. The three-dimensional information with reliability reconstruction unit 110 then outputs the reconstructed three-dimensional information.

The imaging conditions of the SAR image to be analyzed and the reconstructed three-dimensional information are input to the simulated SAR image generation unit 120. The simulated SAR image generation unit 120 generates a complex image showing the steady state for each imaging condition, i.e., a simulated SAR image, using the input imaging condition.

The first change detection unit 130 detects whether a change from the steady state has occurred between the input SAR image to be analyzed and the simulated SAR image.

For example, the first change detection unit 130 calculates a coherence value γ(x^{→}) at each position x^{→} of the SAR image to be analyzed and the simulated SAR image. As mentioned above, the calculated coherence value will be larger when it has not changed from the steady state. When it has changed from the steady state, the calculated coherence value will be smaller.

The first change detection unit 130 displays the coherence value γ(x^{→}) obtained at each position x^{→} in two dimensions, for example. When the SAR image to be analyzed contains a place that has changed from the steady state, the change place is detected as a decrease in the coherence value.

As mentioned above, when simulated SAR images are used, changes are robustly detected even in the layover area. Therefore, as shown in FIG. 21, the first change detection unit 130 can also identify a change detection place in the layover area. In FIG. 21, a frame with dashed lines in a change detection result corresponds to a layover area.

As described above, the first change detection unit 130 in the signal processing device 101 detects changes that have occurred in areas in the SAR image to be analyzed by comparing the SAR image to be analyzed with the simulated SAR image.

For example, the first change detection unit 130 detects changes by calculating a degree of similarity between the SAR image to be analyzed and the simulated SAR image. The first change detection unit 130 may calculate a degree of similarity using the information of the phase indicated by the SAR image to be analyzed and the information of the phase indicated by the simulated SAR image. The degree of similarity is a coherence value, for example.

In this example embodiment, the first change detection unit 130 also inputs reliability information, but in FIG. 21, the input of reliability information is omitted. In other words, FIG. 21 shows a process that does not include the process based on the reliability information described below.

Next, the operation of the signal processing device 101 in this example embodiment to identify the change detection place will be explained with reference to FIG. 22. FIG. 22 is a flowchart showing signal processing performed by the signal processing device 101.

In the signal processing device 101, the three-dimensional information with reliability reconstruction unit 110 performs the three-dimensional information reconstruction process and the process of calculating the reliability index value of the reconstructed three-dimensional information (step S110), as in the first example embodiment.

In the signal processing device 101, the simulated SAR image generation unit 120 performs the simulated SAR image generation process and the process of calculating reliability information, as in the first example embodiment (step S120).

Next, the first change detection unit 130 performs the first change detection process (step S130). The first change detection process is a process to detect changes by executing a correlation process using phase information.

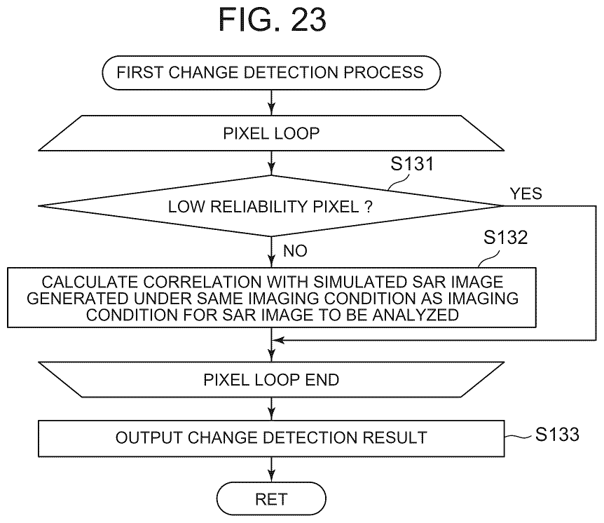

FIG. 23 is a flowchart showing the first change detection process.

In the first change detection process, the first change detection unit 130 repeatedly performs the process of step S132 (change detection process) until it detects changes regarding all pixels between the SAR image to be analyzed and the simulated SAR image generated under the same imaging conditions. In other words, the first change detection unit 130 performs pixel loop processing. The following is an example of a case where correlation process is performed as a change detection process.

The first change detection unit 130 selects one pixel for which the correlation has not yet been calculated from among pixels in the simulated SAR image. In step S132, the first change detection unit 130 calculates the correlation between the selected pixel in the simulated SAR image and the selected pixel in the SAR image to be analyzed. The selected pixel in the SAR image to be analyzed is a pixel at the same position as the selected pixel in the simulated SAR image.

Specifically, the first change detection unit 130 calculates a correlation between the complex signal g_{obs}(x^{→}, n) of the selected pixel in the SAR image to be analyzed and the simulated complex signal gₛᵢₘ(x^{→}, n) of the selected pixel in the simulated SAR image generated under the same imaging condition as the imaging condition for the SAR image to be analyzed. The first change detection unit 130 calculates the correlation using phase information.

For example, the first change detection unit 130 uses the coherence value expressed in the following equation (4) as the correlation. In equation (4), E(·) represents the expected value.

$$\begin{matrix}[ Math . 4 ] & \\ γ ( x , n ) = \frac{E [ {g}_{obs} ( x , n ) {{g}_{sim} ( x , n )}^{*} ]}{E [ {g}_{obs} ( x , n ) {{g}_{obs} ( x , n )}^{*} ] E [ {g}_{sim} ( x , n ) {{g}_{sim} ( x , n )}^{*} ]} & ( 4 )\end{matrix}$$

The first change detection unit 130 may employ values other than the coherence value, which are calculated by the correlation process using the phase information. As an example, the first change detection unit 130 may extract the phase information from the SAR image as a real value and obtain correlation with the extracted real value. As a similarity, the first change detection unit 130 may calculate a difference square between the phase of the selected pixel in the SAR image to be analyzed and the phase of the selected pixel in the simulated SAR image, for example.

In this example embodiment, the first change detection unit 130 does not perform the process of step S132 for pixels with low reliability in the simulated SAR image (step S131). The first change detection unit 130 determines whether the reliability is low or not based on the reliability information input from the simulated SAR image generation unit 120. For example, the first change detection unit 130 determines that the reliability is low when the value indicated by the reliability information is smaller than a predetermined threshold value. In other words, the first change detection unit 130 excludes pixels with low reliability represented by the reliability information from the comparison.

After the first change detection unit 130 performs steps S131 and S132 for the pixels of the simulated SAR image, the first change detection unit 130 exits the pixel loop. After exiting the pixel loop, the first change detection unit 130 outputs the change detection result including the calculated pixel-by-pixel correlations (step S133).

When multiple simulated SAR images are input, the first change detection unit 130 performs the first change detection process of step S130 for each input simulated SAR image.

The signal processing device 101 of this example embodiment has a configuration in which the first change detection unit 130 is added to the signal processing device 100 of the first aspect of the first example embodiment (see FIG. 10). However, by adding the first change detection unit 130 to the signal processing device 200 (see FIG. 12) of the second aspect of the first example embodiment, it is also possible to configure a signal processing device that performs change detection process in the same manner as the present example embodiment.

### Explanation of the Effect

In this example embodiment, in the signal processing device 101, the first change detection unit 130 calculates correlation, etc. between the SAR image to be analyzed and the simulated SAR image generated under the same imaging condition as the imaging condition for the SAR image to be analyzed, using information on the phase. By referring to the correlation, etc. calculated using the phase information, users can easily detect changes from the steady state. In addition, by calculating the correlation, etc. between the simulated SAR image and the SAR image to be analyzed by the first change detection unit 130, users can detect changes robustly even in the layover area.

Further, in this example embodiment, the first change detection unit 130 does not perform change detection process for pixels with low reliability. As a result, changes from the steady state can be detected more accurately even if SAR images showing the steady state contain information other than the steady state.

As shown in FIG. 21, when the first change detection unit 130 projects the change detection result on a two-dimensional map, users can easily identify the change detection place.

Even if multiple times of changes occur over the observation period in the target area, the first change detection unit 130 can detect each change as a change from the steady state, by calculating the correlation between the multiple SAR images to be analyzed and the simulated SAR image corresponding to each change.

In case that multiple change detection results are obtained, when the first change detection unit 130 displays the multiple change detection results in chronological order, users can easily identify each change detection place and each change detection time.

### Example Embodiment 3

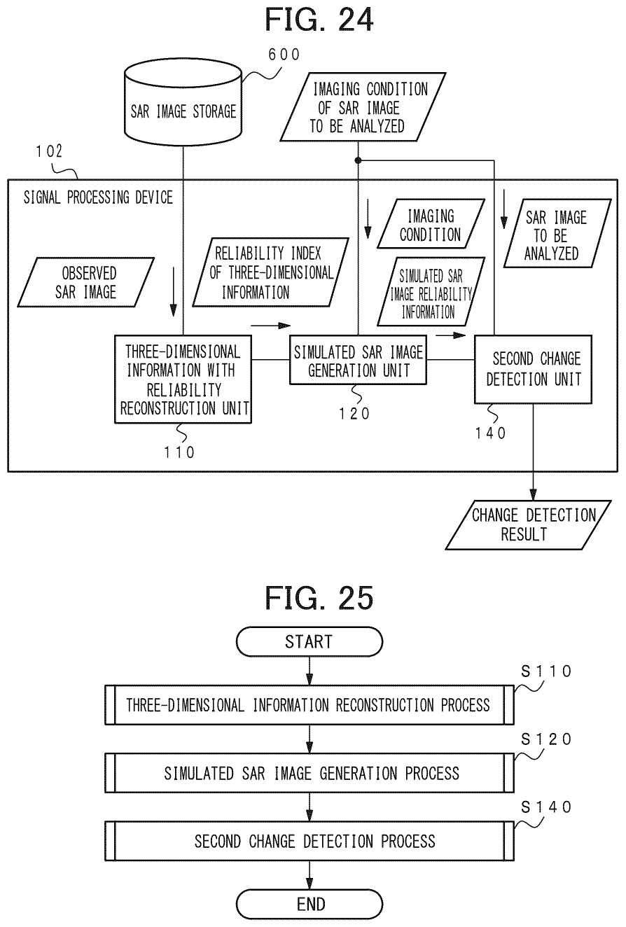

Next, a third example embodiment of the present invention will be explained with reference to the drawings. FIG. 24 is a block diagram showing a configuration example of the signal processing device of the third example embodiment of the present invention.

A signal processing device 102 shown in FIG. 24 includes a three-dimensional information with reliability reconstruction unit 110, a simulated SAR image generation unit 120, and a second change detection unit 140. As shown in FIG. 24, the signal processing device 102 inputs the observed SAR image from the SAR image storage 600.

The functions of the three-dimensional information with reliability reconstruction unit 110 and the simulated SAR image generation unit 120 in this example embodiment are the same as those of the three-dimensional information with reliability reconstruction unit 110 and the simulated SAR image generation unit 120 in the first example embodiment.

The multiple SAR images to be analyzed are input to the second change detection unit 140. The SAR images to be analyzed include received signals indicating information on intensity and a phase. The imaging conditions of the multiple SAR images to be analyzed are input to the second change detection unit 140. Each of the imaging conditions is the same as each of the multiple imaging conditions input to the simulated SAR image generation unit 120. The multiple simulated SAR images corresponding to respective multiple imaging conditions are input to the second change detection unit 140 from the simulated SAR image generation unit 120. Further, the reliability information at each pixel is input to the second change detection unit 140 from the simulated SAR image generation unit 120.

The second change detection unit 140 performs a correlation process using phase information for each pair of the SAR image to be analyzed and the simulated SAR image corresponding to the SAR image to be analyzed. Further, the second change detection unit 140 outputs statistics obtained from the values calculated for each pair as a change detection result. As a statistic the average or median of the values calculated by the correlation process using the phase information can be used, for example.

The second change detection unit 140 may compare the statistics with a predetermined threshold value and output information (data) indicating the presence or absence of a change based on the comparison result as a change detection result.

Next, the operation of the signal processing device 102 of this example embodiment to identify a change detection place will be explained with reference to FIG. 25. FIG. 25 is a flowchart showing signal processing performed by the signal processing device 102.

In the signal processing device 102, the three-dimensional information with reliability reconstruction unit 110 performs the three-dimensional information reconstruction process and the process of calculating the reliability index value of the reconstructed three-dimensional information as in the first example embodiment (step S110).

In the signal processing device 102, the simulated SAR image generation unit 120 performs the simulated SAR image generate process and the process to calculate reliability information as in the first example embodiment (step S120).

Next, the second change detection unit 140 performs the second change detection process (step S140). The second change detection process is a process to detect changes by executing a correlation process using phase information for each pair of simulated SAR images corresponding to the SAR image to be analyzed and using statistics obtained from the multiple correlations calculated.

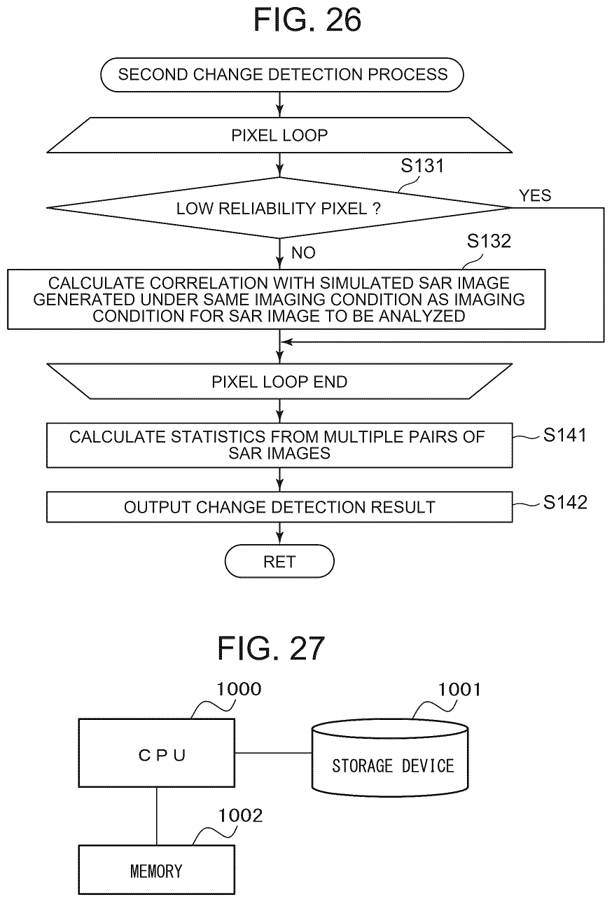

FIG. 26 is a flowchart showing the second change detection process.

The second change detection unit 140 performs the pixel loop processing including the processes of steps S131 and S132, as in the second example embodiment. In this example embodiment, the second change detection unit 140 performs the pixel loop processing for all pairs with the simulated SAR image corresponding to the SAR image to be analyzed. Therefore, in this example embodiment, the image correlation is calculated for all of the pairs with the simulated SAR image corresponding to the SAR image to be analyzed.

Similar to the first change detection unit 130 in the second example embodiment, the second change detection unit 140 does not perform the process of step S132 for pixels with low reliability in the simulated SAR image.

Next, the second change detection unit 140 calculates statistics of the values calculated by the correlation process for each pair (step S141). Then, the second change detection unit 140 outputs a change detection result including the calculated statistics (step S142).

The signal processing device 102 of this example embodiment has a configuration in which the second change detection unit 140 is added to the signal processing device 100 of the first aspect of the first example embodiment (see FIG. 10). However, by adding the second change detection unit 140 to the signal processing device 200 of the second aspect of the first example embodiment (see FIG. 12), it is also possible to configure a signal processing device that performs change detection process based on statistics in the same way as the present example embodiment.

### Explanation of the Effect

When statistics are used as in this example embodiment, it is possible to evaluate not only the high or low value of a single correlation, but also the difference of each correlation from a typical value (for example, average value). As a result, robustness of change detection is improved.

Further, in this example embodiment, the second change detection unit 140 does not perform change detection process for pixels with low reliability. As a result, changes from the steady state can be detected more accurately even if SAR images showing the steady state contain information other than the steady state.

For example, the signal processing device 101 of the second example embodiment and the signal processing device 102 of the third example embodiment are utilized in detecting changes that occur in urban areas without people going there directly. The signal processing devices 101 and 102 can also be utilized in quickly detecting when and where changes occur in a regularly monitored area.

The signal processing devices 101, 102 can also be utilized to monitor military bases and cities in areas of concern from a security perspective. The reason for this is that users of the signal processing devices 101, 102 can quickly capture the appearance of aircraft and vehicles in a surveillance area simply by comparing the SAR image to be analyzed with a simulated SAR image.

The three-dimensional information estimated by the three-dimensional information with reliability reconstruction unit 110 in SAR tomography may be stored on a server or the like. When the three-dimensional information is stored on a server or the like, users of the signal processing devices 100, 102 can generate simulated SAR images that include the area subject to change detection. In other words, the users do not need to reconstruct the three-dimensional information themselves.

For example, when creating training data for object detection in SAR images using machine learning, when the output of the first change detection unit 130 is added to the machine learning, the position of the object assigned to the training data is limited to the output area of the first change detection unit 130. Namely, the range of annotation becomes narrower and the cost of learning is reduced.

Each component in each of the above example embodiments may be configured with a single piece of hardware, but can also be configured with a single piece of software. Alternatively, the components may be configured with a plurality of pieces of hardware or a plurality of pieces of software. Further, part of the components may be configured with hardware and the other part with software.

The functions (processes) in the above example embodiments may be realized by a computer having one or more processors such as one or more central processing units (CPUs), a memory, etc. For example, a program for performing the method (processing) in the above example embodiments may be stored in a storage device (storage medium), and the functions may be realized with the CPU executing the program stored in the storage device.

FIG. 27 is a block diagram of a computer with a CPU. The computer is implemented in the signal processing device. The CPU 1000 executes processing in accordance with a program (signal processing program) stored in a storage device 1001 to realize the functions of the three-dimensional information with reliability reconstruction unit 110, the three-dimensional information with reliability estimation unit 210, the simulated SAR image generation units 120, 220, the first change detection unit 130, and the second change detection unit 140 in the above example embodiments.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disk), a CD-ROM (Compact Disc-Read Only Memory), a CD-R (Compact Disc-Recordable), a CD-R/W (Compact Disc-ReWritable), and a semiconductor memory (for example, a mask ROM, a PROM (programmable ROM), an EPROM (Erasable PROM), a flash ROM).

The program may be stored in various types of transitory computer readable media. The transitory computer readable medium is supplied with the program through, for example, a wired or wireless communication channel, i.e., through electric signals, optical signals, or electromagnetic waves.

The memory 1002 is storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

A DSP (Digital Signal Processor) may be implemented in the signal processing device instead of the CPU 1000. A CPU 1000 and a DSP may also be implemented in the signal processing device.

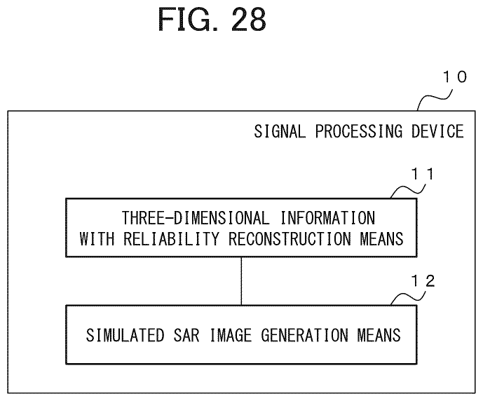

The following is an overview of the present invention. FIG. 28 is a block diagram showing the main part of the signal processing device of the present invention. The signal processing device 10 shown in FIG. 28 comprises three-dimensional information with reliability reconstruction means (three-dimensional information with reliability reconstruction unit) 11 (in the example embodiments, realized by the three-dimensional information with reliability reconstruction unit 110 or the three-dimensional information with reliability estimation unit 210) for generating three-dimensional information with reliability including three-dimensional information constructed with estimated values of intensity and a phase at a three-dimensional position in a steady state reconstructed using an observed SAR image, and information indicating reliability of the three-dimensional information, and simulated SAR image generation means (simulated SAR image generation unit) 12 (in the example embodiments, realized by the simulated SAR image generation units 120, 220) for generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.

In the signal processing device 10, the reliable three-dimensional information reconstruction means 11 (for example, the reliable three-dimensional information reconstruction unit 110) calculates information indicating the reliability of the three-dimensional information by evaluating a discrepancy between a received signal and a predicted signal predicted from the generated three-dimensional information for each of the intensity and the phase, for example.

In the signal processing device 10, the three-dimensional information with reliability reconstruction means 11 (for example, the three-dimensional information with reliability reconstruction unit 110) evaluates how reliable each estimate in the reconstructed three-dimensional information is among the possible values, for example.

In the signal processing device 10, the simulated SAR image generation means 12 (for example, the simulated SAR image generation unit 120) generates reliability information by statistical processing using the generated simulated SAR image and the information indicating reliability of the three-dimensional information, for example.

In the signal processing device 10, the three-dimensional information with reliability reconstruction means 11 (for example, the three-dimensional information with reliability estimation unit 210) a function that expresses information about how reliable what values are as the intensity and the phase at each position in a three-dimensional space as the three-dimensional information with reliability, for example.

In the signal processing device 10, the simulated SAR image generation means 12 (for example, the simulated SAR image generation unit 220) estimates multiple simulated complex signal candidates estimated from the three-dimensional information with reliability and reliability of each simulated complex signal candidate, and selects or generates a likely simulated complex signa as the reliability information, for example.

The signal processing device 10 may include a change detection means (in the example embodiment, realized by the first change detection unit 130 or the second change detection unit 140) for detecting a change in an area in the SAR image to be analyzed by comparing the SAR image to be analyzed with the simulated SAR image, wherein the change detection means excludes a pixel with low reliability represented by the reliability information from comparison target (see step S131 in FIG. 23 and FIG. 26).

The detection means may detect the change by calculating a degree of similarity between the SAR image to be analyzed and the simulated SAR image.

Although the present invention has been described above with reference to the example embodiments, the present invention is not limited to the above example embodiments. Various changes can be made to the configuration and details of the present invention that can be understood by those skilled in the art within the scope of the present invention.

### Reference Signs List

10, 100, 101, 102, 200 Signal processing device
11 Three-dimensional information with reliability reconstruction means
12 Simulated SAR image generation means
110 Three-dimensional information with reliability reconstruction unit
120, 220 Simulated SAR image generation unit
130 First change detection unit
140 Second change detection unit
210 Three-dimensional information with reliability estimation unit
600 SAR image storage
1000 CPU
1001 Storage device
1002 Memory

What is claimed is:

1. A signal processing device, comprising:
a memory storing software instructions, and
one or more processors configured to execute the software instructions to
three-dimensional information with reliability including three-dimensional information constructed with estimated values of reflection intensity and a phase at a three-dimensional position in a steady state reconstructed using an observed SAR image, and information indicating reliability of the three-dimensional information, and
generates a simulated SAR image which is a complex image representing the steady state suitable for an imaging condition of a SAR image to be analyzed, using the three-dimensional information and the imaging condition of the SAR image to be analyzed, and calculating calculate reliability information representing the reliability of the simulated SAR image.

2. The signal processing device according to claim 1, wherein the one or more processors are configured to execute the software instructions to
calculate information indicating the reliability of the three-dimensional information by evaluating a discrepancy between a received signal and a predicted signal predicted from the generated three-dimensional information for each of the reflection intensity and the phase.

3. The signal processing device according to claim 1, wherein the one or more processors are configured to execute the software instructions to
evaluate how reliable each estimate in the reconstructed three-dimensional information is among the possible values.

4. The signal processing device according to claim 2, wherein the one or more processors are configured to execute the software instructions to
generate reliability information by statistical processing using the generated simulated SAR image and the information indicating reliability of the three-dimensional information.

5. The signal processing device according to claim 1, wherein the one or more processors are configured to execute the software instructions to
calculate a function that expresses information about how reliable what values are as the intensity and the phase at each position in a three-dimensional space as the three-dimensional information with reliability.

6. The signal processing device according to claim 5, wherein the one or more processors are configured to execute the software instructions to
estimate multiple simulated complex signal candidates estimated from the three-dimensional information with reliability and likelihood of each simulated complex signal candidate, and select or generate a likely simulated complex signa as the reliability information.

7. The signal processing device according to claim 1, wherein the one or more processors are further configured to execute the software instructions to
detect a change in an area in the SAR image to be analyzed by comparing the SAR image to be analyzed with the simulated SAR image, and wherein
the one or more processors are configured to execute the software instructions to exclude a pixel with low reliability represented by the reliability information from comparison target.

8. The signal processing device according to claim 7, wherein the one or more processors are configured to execute the software instructions to
detect the change by calculating a degree of similarity between the SAR image to be analyzed and the simulated SAR image.

9. The signal processing device according to claim 8, wherein the one or more processors are configured to execute the software instructions to
calculate the degree of similarity using phase information indicated by the SAR image to be analyzed and phase information indicated by the simulated SAR image.

10. The signal processing device according to claim 8, wherein the one or more processors are configured to execute the software instructions to
generate the simulated SAR image for each of the imaging conditions of the multiple SAR images to be analyzed, and
calculate the degree of similarity between the SAR image to be analyzed and the simulated SAR image for each pair of the SAR image to be analyzed and the simulated SAR image, and detects the change using calculated multiple degrees of similarity.

11. A signal processing method, implemented by a processor, comprising:
generating three-dimensional information with reliability including three-dimensional information constructed with estimated values of reflection intensity and a phase at a three-dimensional position in a steady state reconstructed using an observed SAR image, and information indicating reliability of the three-dimensional information, and
generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.

12. A non-transitory computer readable storage medium for storing a signal processing program for causing a computer to execute:
generating three-dimensional information with reliability including three-dimensional information constructed with estimated values of reflection intensity and a phase at a three-dimensional position in a steady state reconstructed using an observed SAR image, and information indicating reliability of the three-dimensional information, and
generating a simulated SAR image which is a complex image representing the steady state suitable for an imaging condition of a SAR image to be analyzed, using the three-dimensional information and the imaging condition of the SAR image to be analyzed, and calculating reliability information representing the reliability of the simulated SAR image.
